(19) United States
(12) Patent Application Publication
(10) Pub. No.: US 2023/0079446 A1
(43) Pub. Date: Mar. 16, 2023

(54) COMPOSITE ADSORBENT-CONTAINING BODIES AND RELATED METHODS

(71) Applicant: ENTEGRIS, INC., Billerica, MA (US)

(72) Inventors: Rocky Dean Gipson, Arroyo Grande, CA (US); Ed A. Sturm, New Milford, CT (US); Subhash Guddati, Singapore (SG); Thines Kumar Perumal, Singapore (SG); Montray Leavy, Singapore (SG)

(21) Appl. No.: 17/945,594

(22) Filed: Sep. 15, 2022

Related U.S. Application Data
(60) Provisional application No. 63/244,520, filed on Sep. 15, 2021.

(51) Int. Cl. B01J 20/28; B01D 53/04; B01J 20/22; B01J 20/20; B01J 20/26; B01J 20/18

(52) U.S. Cl. CPC B01J 20/2803; B01D 53/0446; B01J 20/226; B01J 20/20; B01J 20/26; B01J 20/18; B01J 20/28045; B01D 2253/25; B01D 2257/102; B01D 2257/11; B01D 2257/204

(57) ABSTRACT

Described are composite adsorption media that contain two or more different types of adsorbent material in binder, that may preferably be prepared by additive manufacturing techniques, as well as methods of preparing the structures by additive manufacturing methods.

### CROSS-REFERENCE TO RELATED APPLICATIONS

This application claims the benefit under 35 USC 119 of U.S. Provisional Patent Application No. 63/244,520, filed Sep. 15, 2021, the disclosure of which is hereby incorporated herein by reference in its entirety.

### FIELD

The described invention relates to composite adsorption media that contain two or more different types of adsorbent material and binder, and that may preferably be prepared by additive manufacturing techniques, as well as methods of preparing the structures by additive manufacturing methods.

### BACKGROUND

In the manufacture of semiconductor materials and devices, and in various other industrial processes and applications, there is a need for reliable sources of highly pure gaseous materials (“reagent gases”) used for chemical processing or for manufacturing steps.

Example reagent gases include gases that are used in processing semiconductor materials or microelectronic devices, such as by: ion implantation, epitaxial growth, plasma etching, reactive ion etching, metallization, physical vapor deposition, chemical vapor deposition, atomic layer deposition, plasma deposition, photolithography, cleaning, and doping, among others, with these uses being included in methods for manufacturing semiconductor, microelectronic, photovoltaic, and flat-panel display devices and products, among others.

Examples of specific reagent gases used in some of these processes include silane, germane, ammonia, phosphine, arsine, diborane, stibine, hydrogen sulfide, hydrogen selenide, hydrogen telluride, digermane, acetylene, methane, and corresponding and other halide (chlorine, bromine, iodine, and fluorine) compounds. The gaseous hydrides arsine (AsH₃) and phosphine (PH₃) are commonly used as sources of arsenic (As) and phosphorous (P) in ion implantation. Due to their extreme toxicity and relatively high vapor pressure, the use, transportation, or storage of these gases raises significant safety concerns. These gases must be stored, transported, handled, and used with a high level of care and with many safety precautions.

One useful mode for storing and delivering these types of reagent gases is with an adsorbent-type storage system. With adsorbent-type storage systems a solid adsorbent material is typically contained in a storage container to which is added a useful, high-value raw material in gaseous form (“reagent gas”). The reagent gas becomes adsorbed on surfaces of the adsorbent material for subsequent release from the storage container.

The need for extremely high purity of reagent gases used in certain commercial processes drives continuous research to improve levels of purity of reagent gases. Much of the research focuses on ways to reduce levels of impurities that are present in a reagent gas during the preparation, storage, transport, and delivery of the reagent gas. Specific modes of increasing purity levels of a reagent gas include filtering the reagent gas to remove impurities.

### SUMMARY

In one aspect, the invention relates to composite adsorption media that comprises: first adsorbent particles, second adsorbent particles, and binder that holds together the first adsorbent particles and the second adsorbent particles as composite adsorption media.

In another aspect the invention relates to a method of adsorbing multiple different gases contained in a gas mixture onto composite adsorption media. The method includes: contacting a gas mixture with composite adsorption media that comprises first adsorbent particles, second adsorbent particles, and binder that holds together the first adsorbent particles and the second adsorbent particles as composite adsorption media; adsorbing a first gas contained in the gas mixture onto the first adsorbent particles; and adsorbing a second gas contained in the gas mixture onto the second adsorbent particles.

In another aspect the invention relates to a method of making a composite adsorption media. The method includes: forming a first feedstock layer on a surface, the feedstock layer comprising feedstock that includes first adsorption media particles and second adsorption media particles; forming solidified feedstock from the first feedstock layer; forming a second feedstock layer over the first feedstock layer, the second feedstock layer comprising feedstock that includes first adsorption media particles and second adsorption media particles; forming second solidified feedstock from second feedstock layer. The combination first and second feedstock layers form a multilayer composite that contains the first adsorption media particles and second adsorption media particles.

In yet another aspect, the invention relates to a method of preparing composite adsorption media for processing a gas mixture. The method includes: for a gas mixture that includes a first gas and a second gas, selecting first adsorbent particles to adsorb the first gas, selecting second adsorbent particles to adsorb the second gas; and forming a composite adsorption media that includes the first adsorbent particles, the second adsorbent particles, and binder that holds together the first adsorbent particles and the second adsorbent particles as composite adsorption media.

### BRIEF DESCRIPTION OF THE DRAWINGS

FIGS. 1, 2, 3A, and 3B show examples of systems and methods of using composite adsorption media to separate gases of a gas mixture, as described.

FIGS. 4A, 4B, 5A, 5B, 6A, 6B, 7A, 7B, and 7C show example steps of methods as described of forming a multi-layer composite adsorption media by additive manufacturing techniques.

All figures are schematic and not to scale.

### DETAILED DESCRIPTION

Following is a description of “composite adsorption media,” meaning adsorption media that contains at least two different types of adsorbent particles combined into a single, solid adsorption medium, and held together by binder. The two different types of adsorbent particles are effective to adsorb at least two different gaseous constituents of a gas mixture.

The composite is made of materials that include a first type of adsorbent, second type of adsorbent that is functionally different from the first type of adsorbent based on an affinity for adsorbing a different gas, and binder. The first adsorbent and the second adsorbent are held together by the binder to form a porous matrix that makes up the composite adsorption media.

Preferred composites can be considered to be relatively “homogeneous,” meaning that the first adsorbent particles and the second adsorbent particles, as well as any additional adsorbent particles, are evenly distributed throughout a composite body while being held together by the binder, which is also evenly distributed throughout the composite body.

On a microscopic scale, e.g., with magnification, most or all portions of a homogeneous composite body will appear substantially alike visually with respect to relative amounts of different adsorbent particles and binder; also, the different adsorbent particles are distributed in a substantially even and uniform manner through the homogeneous composite body, with the first adsorbent particles and the second adsorbent particles being present in equal concentrations and similarly distributed throughout a composite.

A homogeneous composite can also exhibit a substantially uniform composition based on compositional analysis. Various samples of portions of the composite can be analytically tested to identify the chemical makeup of the composite, such as by testing for metal content (concentration). The samples of a homogeneous composite will have a similar chemical makeup, such as a concentration of one or more metals that is within 1 percent, or within 0.5 or 0.1 percent. One example of a useful analytical technique is scanning electron microscopy energy-dispersive spectroscopy (SEM/EDS) (sometimes called energy dispersive X-ray analysis (EDXA) or energy dispersive X-ray microanalysis (EDXMA).

The composite contains at least two different types of adsorbent particles, each being effective to adsorb a different type of gaseous constituents of a gas mixture. The different types of adsorbent particles can be selected based on adsorption properties, which may be based on size selectivity or thermodynamic selectivity. Based on size selectivity, certain types of adsorbents will adsorb molecules of smaller sizes, while other adsorbents will adsorb molecules of larger sizes. Zeolite adsorbents can have smaller pore sizes and adsorb relatively smaller particles, such as certain types of impurities (e.g., HF). Based on thermodynamic selectivity, certain types of adsorbents will adsorb molecules of different chemical affinity for different chemical molecules.

In certain examples, the first and second adsorbents can be selected to adsorb two different gases that are present in a gas mixture that includes a high value gas, referred to as a “reagent gas,” and an impurity gas that is known to be present in the high value reagent gas.

The first adsorbent is selected to effectively adsorb and to selectively desorb the reagent gas. Example reagent gases include raw materials that are useful in commercial manufacturing processes. Examples include: silane, germane, ammonia, phosphine, arsine, diborane, stibine, hydrogen sulfide, hydrogen selenide, hydrogen telluride, digermane, acetylene, methane, and corresponding and other halide (chlorine, bromine, iodine, and fluorine) compounds. The gaseous hydrides arsine (AsH₃) and phosphine (PH₃) are commonly used as sources of arsenic (As) and phosphorous (P) in ion implantation.

In these examples, where a first adsorbent is effective to adsorb a first gas that is a “high value” reagent gas, the second adsorbent can be one that is effective to adsorb a second gas that is different from the first gas and that is an unwanted gas, e.g., an impurity gas, that is present in the reagent gas. Whereas the first gas may be a “high value” gas that is useful in a commercial manufacturing process or otherwise desired to be collected for use value, the second gas may be an impurity gas that is known to be present in a low amount with the first gas, as a mixture of the first gas and the second gas. The gas mixture may be a mixture that contains a high concentration of the high value gas (e.g., a reagent gas), such as at least 90, 95, 99, or 99.9 percent (by volume), in combination with the impurity gas as the second gas with the impurity gas being present in a low amount, such as below 0.1, 0.01, or 0.001 percent by volume or lower, such as at a concentration in a parts per million (ppm) or parts per billion (ppm) range.

In certain examples, a first gas may be germane, and an impurity may be digermane, which is present in a very low amount as an impurity in otherwise highly pure germane. In this specific example, the first adsorbent that is effective to adsorb germane may be a zeolite or a metal-organic-framework adsorbent.

As other examples, a gas mixture may contain: reagent gas that is a specialty hydride or halides, with water as an impurity; a reagent gas that is a hydride (e.g., SiH₄, GeH₄, AsH₃, etc.) and hydrogen as an impurity; reagent gas that is phosphine with diphosphine as an impurity. A reagent gas may be a high value specialty gas, with an impurity that is a hydrated by-products or ionized fragments of the high value specialty gas. A reagent gas may be a high value fluoride (BF₃, GeF₄, SiF₄, PF₃, etc.), with hydrogen fluoride (HF) as an impurity. Other gas mixtures may be an exhaust gas flowing from a manufacturing or chemical processing step that contains a high value reagent gas, with an impurity that is an inert gas such as nitrogen, helium, xenon, or argon.

Desirably, the combination of the first and second adsorbents may be present in relative amounts in the composite adsorption media to adsorb both the first gas (e.g., high value reagent gas) and the second gas (impurity gas) in approximate amounts at which they are present in the gas mixture.

In other examples of composite adsorption media, the adsorption media can contain a first and a second adsorbent, with each adsorbent being effective to adsorb an impurity that is known to be present within a reagent gas. The first adsorbent effectively adsorbs a first impurity, the second adsorbent effectively adsorbs a second impurity, and both the first adsorbent and the second adsorbent are not effective to adsorb the reagent gas.

Desirably, the combination of the first and second adsorbents in these example composite adsorption media may also be present in relative amounts in the composite adsorption media to adsorb both the first and the second gases, both being impurities in a reagent gas, in approximate amounts at which the first and second impurity gases are present in the gas mixture.

A variety of different types of adsorbent materials are known and are available as particles for use as described herein. General types of adsorbent particles include carbon-based adsorption particles, polymeric adsorption particles that include porous organic polymers (POP), polymer framework particles (PF), zeolitic adsorption particles (“zeolites”), silicalite particles, and metal-organic-framework particles (MOF).

Useful metal-organic-framework (MOF) adsorbent materials exhibit various physical and molecular forms. Metal-organic frameworks are organic-inorganic hybrid crystalline porous materials that have molecular structures that include a regular repeating array of positively charged metal ions surrounded by organic “linker” molecules. The metal ions form nodes that bind the arms of the organic linker molecules together to form a repeating, hollow cage-like structure. With this hollow structure, MOFs have an extraordinarily large internal surface area that can be adapted for use to adsorb (and selectively desorb) reagent gas in an adsorbent-type storage system. These features of the MOF molecules must be retained, not substantially disrupted or damaged, during a useful additive manufacturing process for forming a multi-layer composite adsorption media.

Metal organic frameworks (MOFs) are nanoporous materials consisting of organic linkers coordinated to metal ions in crystalline structures. Various MOF adsorbent materials are known in the reagent gas, reagent gas storage, and gas separations arts. Certain examples of MOF materials are described in U.S. Pat. No. 9,138,720, and also in United States Patent Application Publication 2016/0130199, the entireties of each of these documents being incorporated herein by reference.

A subclass of MOFs that are known as zeolitic adsorbents include zeolitic imidazolate frameworks (“ZIFs”), which consist of metal (mainly tetrahedral Zn2) bridged by the nitrogen atoms of imidazolate linkers. Zeolitic imidazolate frameworks are a type of MOF that includes a tetrahedrally-coordinated transition metal such as iron (Fe), cobalt (Co), Copper (Cu), or Zinc (Zn), connected by imidazolate linkers, which may be the same or different within a particular ZIF composition or relative to a single transition metal atom of a ZIF structure. The ZIF structure includes four-coordinated transition metals linked through imidazolate units to produce extended frameworks based on tetrahedral topologies. ZIFs are said to form structural topologies that are equivalent to those found in zeolites and other inorganic microporous oxide materials.

A zeolitic imidazolate framework can be characterized by features that include the type of transition metal (e.g., iron, cobalt, copper, or zinc), the chemistry of the linker (e.g., chemical substituents of the imidazolate units), pore size of the ZIF, surface area of the ZIF, pore volume of the ZIF, among other physical and chemical properties. Dozens (at least 105) of unique ZIF species or structures are known, each having a different chemical structure based on the type of transition metal and the type of linker (or linkers) that make up the framework. Each topology is identified using a unique ZIF designation, e.g., ZIF-1 through ZIF-105. For a description of ZIFs, including particular chemical compositions and related properties of a large number of known ZIF species, see Phan et al., “Synthesis, Structure, and Carbon Dioxide Capture Properties of Zeolitic Imidazolate Frameworks,” Accounts of Chemical Research, 2010, 43 (1), pp 58-67 (Received Apr. 6, 2009).

Some examples of carbon adsorbent materials include: carbon formed by pyrolysis of synthetic hydrocarbon resins such as polyacrylonitrile, sulfonated polystyrene-divinylbenzene, etc.; cellulosic char; charcoal; activated carbon formed from natural source materials such as coconut shells, pitch, wood, petroleum, coal, etc.

Adsorbent particles can have properties such as particle size, pore size, and pore volume, which can depend on the type of adsorbent. These properties of adsorbent particles in a composite adsorption media can be selected based on a particular type of gas of a gas mixture that will be adsorbed by the adsorbent particles.

In general, useful or preferred particle size for preparing a composite adsorption media using additive manufacturing techniques as described herein may be in a range from 2 microns to 20 microns, although larger or smaller adsorbent particles may also be useful. Particle size of adsorbent particles can be measured by known techniques, including sieving techniques.

In some embodiments, the composite adsorption media disclosed herein have a first adsorbent particles may vary from greater than 0 to less than 100 percent by volume or weight of the adsorbent particles in the composite adsorption media and the second adsorbent particles may vary from greater than 0 to less than 100 percent by volume or weight of the total adsorbent particles in the composite adsorption media. Thus the composite adsorption media may have the same or different weight or volume percentage of first adsorption particles and second adsorption particles.

Binder that is useful in a composite adsorption media can be any material that is capable of being combined with two or more different types of adsorbent particles and solidified to form a composite as described. Examples include organic materials such as polymers (e.g., synthetic polymers or natural polymers, either of which may optionally be chemically curable), inorganic materials such as clays and other inorganic particles, fugitive materials, etc.

The composite adsorption media can be useful to separate gases that are contained in a gas mixture. The gas mixture may typically include a high value reagent gas and one, two, or more other gases that are different from the reagent gas.

According to some example uses, a composite adsorption media may be useful to purify a reagent gas in a gas mixture by adsorbing multiple different impurity gases from a gas mixture that contains the reagent gas in a purified form (optionally in combination with an inert stabilizing gas or diluent), along with the two different impurities at concentrations that are typical of an impurity. The composite adsorption media can be used in effect as a filter by passing the gas mixture through the composite adsorption media. The gas mixture contacts the composite adsorption media and impurities are adsorbed onto the composite adsorption media while the reagent gas is not adsorbed and passes through the adsorption media with a reduced amount of the impurities. In use, the vessel that contains the reagent gas with impurities delivers the reagent gas as a gaseous raw material to process equipment that uses the reagent gas as a raw material, for example a tool for processing or manufacturing semiconductor wafers or microelectronic devices; non-limiting examples include ion implantation tools and depositing tools, e.g., for chemical vapor deposition (including variations such as plasma-assisted chemical vapor deposition), physical deposition (e.g., sputtering), atomic layer deposition, and the like.

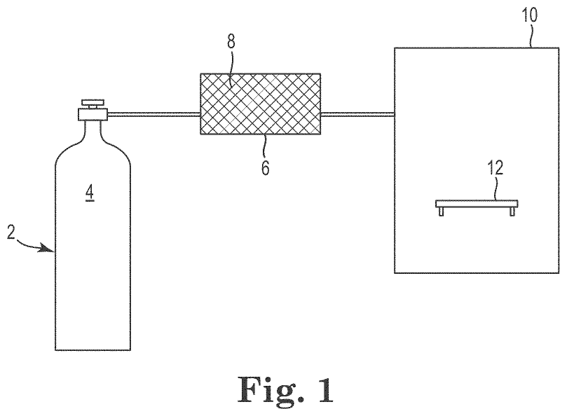

A specific example of this application is shown at FIG. 1. In this example a composite adsorption media can be used to further purify an already purified stored raw material gas at a point of use, immediately or shortly before the reagent gas is supplied to a manufacturing step, e.g., as the gas is delivered from a storage vessel for use in the manufacturing step.

As illustrated, storage vessel 2 includes reagent gas 4 in a highly purified, optionally concentrated form. Reagent gas 4 is highly purified, for example may have a purity in excess of 99, 99.9, or 99.99 percent. In some processes the reagent gas may be diluted with an inert stabilizing gas such as helium, nitrogen, hydrogen, argon, or the like, with the inert gas being present in a concentration of greater than 10, 50, or 70 percent. The reagent gas contains two or more known impurities, each of which is different from the reagent gas and different from the optional stabilizing gas. Each of the two impurities is present at a concentration that is typical of an impurity, such as at a concentration below 0.1, 0.01, or 0.001 percent, or lower by volume such as at a concentration in a parts per million (ppm) or parts per billion (ppm) range, based on total volume of the gas mixture.

Either of the impurities may be of a type that is initially present in the reagent gas, storage vessel, or adsorbent that is contained in the storage vessel at the time that the reagent gas was added to the storage vessel (e.g., an atmospheric impurity such as nitrogen (N₂), oxygen (O₂), methane (CH₄), water vapor (H₂O), carbon dioxide (CO₂), hydrogen (H₂), or carbon monoxide (CO)). Other types of impurities may have been generated within the storage vessel during storage of the reagent gas, during a time after the reagent gas was loaded into the storage vessel. This may occur, for example, by the reagent gas chemically degenerating or decomposing to a derivative of the reagent gas, which is the impurity. As yet a different source of impurity, an impurity may be generated during storage of the reagent gas by a chemical interaction between the reagent gas and another material that is also contained in the storage vessel such as an inert gas, a material of a storage vessel sidewall, a different impurity, or a material of an adsorbent.

Vessel 2 may be any useful storage vessel that is adapted to be used to contain, store, or transport reagent gas 4 in a high-pressure, low-pressure, or sub-atmospheric stored condition. Vessel 2 contains an interior volume that contains the reagent gas, and may contain adsorbent to store the reagent gas, or may be a high-pressure vessel that does not contain adsorbent. A valve or other dispensing mechanism is located at an opening of the vessel to allow reagent gas to be added to and subsequently dispensed from the interior volume. The vessel can be filled at a first location, transported to a sit of use (e.g., a clean room), and held at the site of use to supply the reagent gas to processing tool 10, containing semiconductor wafer 12, for example a tool for processing or manufacturing semiconductor wafers or microelectronic devices.

According to these systems and methods, reagent gas 4 is dispensed from vessel 2 and passes through a conduit into housing 6 that contains composite adsorption media 8. Composite adsorption media 8 includes two different types of adsorbent. One adsorbent is effective to adsorb an amount of a first of the two impurities, the amount being at least some of the first impurity (e.g., at least 50 percent), preferably a substantial amount or substantially all of the first impurity (e.g., at least 75, 90, or 95 percent). A second adsorbent is effective to adsorb an amount of the second of the two impurities, the amount being at least some of the second impurity (e.g., at least 50 percent), preferably a substantial amount or substantially all of the second impurity (e.g., at least 75, 90, or 95 percent). Composite adsorption media 8 does not contain any adsorbent that will adsorb a significant amount of the reagent gas, e.g., composite adsorption media 8 adsorbs less than 10, 5, 2, or 1 percent of the reagent gas.

As reagent gas 4 passes through composite adsorption media 8, the first and second impurities are adsorbed in large part onto composite adsorption media 8. The reagent gas, now containing a reduced amount of the impurities, passes from housing 6 and is delivered to processing tool 10, for example through a second conduit. Other flow control devices can be included in the system, such as a flow meter, pressure valve, pressure regulator, pressure and temperature sensors, etc., but are not illustrated.

According to a different example use, a composite adsorption media may be useful as adsorbent material within a storage vessel that is used to contain, store, transport, and dispense a high purity reagent gas to a manufacturing process. The composite adsorption media is contained in a storage vessel, typically a metal cylinder, of a type that is used in the storage, transport, and delivery of highly pure reagent gas to a manufacturing process. The storage vessel may be any useful storage vessel that stores adsorbed reagent gas on an adsorbent material within the vessel and is adapted to contain, store, transport, or dispense the reagent gas from the vessel. The storage vessel may be adapted to contain the reagent gas for transporting the gas, or may be connected to a manufacturing tool to receive reagent gas and separate the reagent gas from an impurity or a stabilizing gas with which the reagent gas was stored and transported.

The reagent gas may be contained in the vessel at high-pressure, low-pressure, or sub-atmospheric stored condition. A valve or other dispensing device is located at an opening of the vessel to allow reagent gas to be added to the vessel interior and selectively dispensed from the interior volume.

According to certain methods, the vessel is filled with reagent gas at a first site (e.g., a site of manufacturing the reagent gas or processing the reagent gas) and is transported to a point of use (e.g., in a clean room). At the point of use the vessel is connected to a processing system that uses the reagent gas as a gaseous raw material, for example a tool for processing or manufacturing semiconductor wafers or microelectronic devices, non-limiting examples being ion implantation tools and depositing tools, e.g., for chemical vapor deposition (including variations such as plasma-assisted chemical vapor deposition), physical deposition (e.g., sputtering), atomic layer deposition, and the like.

In this application, the composite adsorption media is used as an “in-situ” storage purification medium. The composite adsorption media contains at least two different types of adsorbent. A first adsorbent is effective to adsorb and then to selectively desorb a high value reagent gas. The second adsorbent is effective to adsorb an impurity, but does not allow the impurity to desorb under conditions that cause effective desorption of the reagent gas. The system, containing the composite adsorption media in the storage vessel, can be used to purify a reagent gas that is contained and stored in the storage vessel, by the composite adsorption media adsorbing and retaining an amount of impurities that may be contained in the reagent gas when the reagent gas is added to the storage vessel.

More specifically, reagent gas can be added to the vessel in a form that is highly purified, optionally concentrated (e.g., does not contain stabilizing gas), but that is known to contain at least one impurity gas (different from the reagent gas and any optional stabilizing gas). The impurity or may be present in an amount that is typical of an amount of an impurity, e.g., at a concentration below 0.1, 0.01, or 0.001 percent, or lower by volume such as at a concentration in a parts per million (ppm) or parts per billion (ppm) range, based on total volume of the gas mixture.

To store and purify the reagent gas, the reagent gas with impurity (considered a gas mixture that contains the reagent gas and impurity) is added to the vessel that contains the composite adsorption media. The reagent gas with impurity contacts the composite adsorption media and both the reagent gas and the impurity gas are adsorbed onto the adsorption media, each being adsorbed by a different adsorbent material. After the reagent gas and the impurity gas are effectively adsorbed on the adsorption media, the reagent gas can be desorbed from the adsorption media under conditions that do not cause desorption of the impurity gas, e.g., that cause no desorption of the impurity gas or that cause a small or minor amount of desorption of the impurity gas, e.g., less than 20, 10, or 5 percent of the total amount of adsorbed impurity gas may be desorbed. By these steps, the adsorbed and desorbed reagent gas can be further purified, e.g., at least in substantial part, with removal of the impurity gas that is adsorbed and does not desorb with desorption of the reagent gas. The desorbed reagent gas can be delivered to a processing apparatus for use as a gaseous raw material.

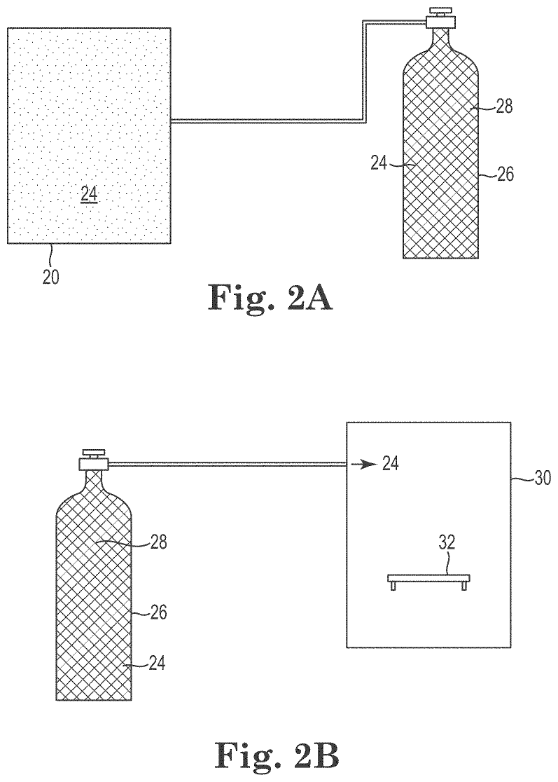

A specific example of this application is shown at FIGS. 2A and 2B. In this example a composite adsorption media can be used to remove impurities from a raw material gas as the gas is added to, contained within, and dispensed from a storage vessel that contains the composite adsorption media.

As illustrated at FIG. 2A, reagent gas 24 is stored in container 20. Container 20 may be any container, for example a bulk container of a type used to store a large volume of reagent gas, e.g., as part of a reagent gas manufacturing or processing system. Reagent gas 24 can be in a substantially pure form and optionally in concentrated form or in a diluted form (e.g., diluted with stabilizing gas). Reagent gas 24 may for example have a purity in excess of 90, 95, 99, 99.9, or 99.99 percent. In some processes the reagent gas may be un-diluted (e.g., reagent gas 24 contains at least 98 or 99 percent by volume of the reagent gas species) and in other processes the reagent gas may be in a mixture with an inert stabilizing gas such as helium, nitrogen, hydrogen, argon, or the like, with the stabilizing gas being present in a gas mixture (reagent gas and stabilizing gas) in a concentration of greater than 10, 50, or 70 percent based on total volume of the gas mixture. Reagent gas 24 contains at least one known impurity, which is different from the reagent gas and the optional stabilizing gas. The impurity is present at a concentration that is typical of an impurity, such as less than 1, 0.1, 0.01, or 0.001 percent, or lower by volume such as at a concentration in a parts per million (ppm) or parts per billion (ppm) range, based on total volume of the gas mixture.

The impurity may be of a type that is present in the reagent gas as a product of step of producing the reagent gas (e.g., a reaction step) or a step of processing the reagent gas after the gas is produced (e.g., an atmospheric impurity such as nitrogen (N₂), oxygen (O₂), methane (CH₄), water vapor (H₂O), carbon dioxide (CO₂), hydrogen (H₂), or carbon monoxide (CO)). The impurity may be a contaminant from the container or from appurtenant flow control equipment. Or the impurity may have been generated within the container during storage of the reagent gas, during a time after the reagent gas was loaded into or processed within the container. This may occur, for example, by the reagent gas chemically degenerating or decomposing to a derivative of the reagent gas, which is the impurity. As yet a different source of impurity, an impurity may be generated during within the container by a chemical interaction between the reagent gas and another material that is also contained in the container, such as an inert gas, a material of the container sidewall or flow equipment, or a different impurity.

Container 20 may be any useful container that is adapted to be used to contain reagent gas 24 in a high-pressure, low-pressure, or sub-atmospheric stored condition. Vessel 24 contains an interior volume that contains the reagent gas, and may contain adsorbent (not shown) to store the reagent gas, or may be a high-pressure vessel that does not contain adsorbent. Container 24 may be adapted to hold reagent gas in a bulk amount, and can include valves and flow controls (not specifically shown) to dispense reagent gas into a single storage cylinder. Optionally the container may be connected to an arrangement of multiple flow control conduits and valves (e.g., multiple “fill ports”) to dispense the reagent gas into multiple storage cylinders in parallel.

According to these systems and methods, reagent gas 24 is dispensed from container 20 and passes through a conduit into storage vessel 26, which contains composite adsorption media 28. Vessel 26 has a volume and performance requirements to allow the vessel to safely contain, store, and transport reagent gas from a location of container 20 to a point of use of the reagent gas. Composite adsorption media 28, at the interior of vessel 26, includes two different types of adsorbent. One adsorbent is effective to adsorb an amount of the reagent gas species. A second adsorbent is effective to adsorb an amount of the known impurity, the amount being at least some of the impurity (e.g., at least 50 percent), preferably a substantial amount or substantially all of the impurity (e.g., at least 75, 90, or 95 percent).

As shown at FIG. 2A, reagent gas 24 is added to vessel 26 to contact adsorption media 28, which causes both the reagent gas species and the impurity contained in the reagent gas are adsorbed onto composite adsorption media 28. Vessel 26 is then transported to a location of use, such as a clean room, as shown at FIG. 2B.

Vessel 26 is connected to processing tool 30, and adsorbed reagent gas 24 is caused to desorb from composite adsorption media 28. The desorption conditions are effective to cause desorption of a substantial amount of the adsorbed reagent gas species, while a large amount or substantially all of the impurity remains adsorbed (e.g., at least 50, 70, or 90 percent of adsorbed impurity remains adsorbed). The desorbed reagent gas, now containing a reduced amount of the impurity, passes from vessel 26 and is delivered to processing tool 30, for example through a second conduit, for processing of a substrate (e.g., semiconductor wafer or microelectronic device) 32. Other flow control devices can be included in the system, such as a flow meter, pressure valve, pressure regulator, pressure and temperature sensors, etc., but are not illustrated.

According to a variation of this method, the bulk vessel may be a storage and transportation vessel that contains the reagent gas, at least one impurity, and a high level (e.g., at least 20, 40, or 60 percent) of inert gas to stabilize the reagent gas during transport. The bulk vessel may or may not contain adsorbent. The bulk vessel delivers the reagent gas and stabilizing gas to a smaller vessel that adsorbs the stabilizing gas and at least one impurity, does not adsorb reagent gas, and then delivers the reagent gas to a manufacturing tool. The smaller vessel, e.g., a ballast cylinder adapted for short-term storage of reagent gas before delivering the reagent gas to the manufacturing tool, contains adsorbent of the present description that contains a composite adsorption media as described. The two types of adsorbent contained in the ballast cylinder are effective to adsorb the inert gas and at least one impurity. The adsorbent does not substantially adsorb the reagent gas, which may either pass through the adsorbent and the vessel or remain in headspace within the vessel as the non-reagent gas becomes adsorbed, after which the reagent gas can be dispensed from the ballast cylinder.

The gas mixture can be flowed from the bulk vessel into the ballast cylinder. In the ballast cylinder, the stabilizing gas and an impurity become adsorbed onto the composite adsorption media. The reagent gas does not become adsorbed and remains in a gaseous state, e.g., within headspace of the ballast cylinder. In that gaseous state the reagent gas can be delivered from the ballast cylinder (without desorbing the adsorbed stabilizing gas and impurity) to the manufacturing tool in a form that contains a reduced concentration of the stabilizing gas (e.g., below 20, 40, or 60 percent stabilizing gas).

According to still another example use, a composite adsorption media may be useful to separate or concentrate an amount of reagent gas that is contained in a gas mixture that comprises the reagent gas and one or more non-reagent gases (e.g., a second gas, a third gas) that are present in significant amounts (greater than an amount of an impurity) in the gas mixture with the reagent gas, or that are present in an amount of an impurity.

The gas mixture may be any gas mixture that contains a significant amount of the reagent gas species, but not a purified amount. The gas mixture may be a mixture of gases from any source, with an example being an exhaust gas from a process that uses the reagent gas as a raw material. The process does not have 100 percent efficient use of the reagent gas, which results in a flow of exhaust gas from the process that contains a significant amount of the un-used reagent gas. The exhaust gas may contain at least 5 and up to 50 or 60 percent of the un-used reagent gas species, e.g., from 10 to 40 percent un-used reagent gas by volume based on total volume of the exhaust gas. The exhaust gas will contain a mixture of other non-regent gases in concentrations of an impurity (e.g., below 0.1, 0.01, or 0.01 percent, or at a concentration in a range of ppm or ppb), or that are higher, e.g., from 1 to 40, 50, or 60 percent by volume based on total volume of the exhaust gas. Examples of non-reagent gases that may be present in an exhaust gas mixture as an impurity or at a higher concentration include hydrogen, nitrogen, helium, xenon, argon that may be selectively removed from the exhaust gas stream by being adsorbed on a composite adsorbent material.

The exhaust gas mixture flows from process equipment that uses the reagent gas as a raw material, and is caused to contact a composite adsorption media as described herein. The composite adsorbent media will adsorb at least two different types of gases within the exhaust gas.

In one version of this method, the composite adsorption media can adsorb two or more different types of the non-reagent gases. The composite adsorption media does not adsorb the reagent gas, which passes through the adsorption media with a reduced concentration of the non-reagent gases, and at a higher concentration of the reagent gas, or remains in headspace of the vessel and can be subsequently removed. The amounts of the non-reagent gases that are adsorbed can be any amounts that are useful to increase the concentration of the reagent gas within the exhaust gas. In example methods, an amount of either or both of the non-reagent gases that is adsorbed by the composite adsorption media may be at least some of the non-reagent gas (e.g., at least 50 percent), preferably a substantial amount or substantially all of the non-reagent gas (e.g., at least 75, 90, or 95 percent) that is contained in the exhaust gas mixture. By this use of the composite adsorption media effectively as a flow-through filter, non-reagent gas of the exhaust gas mixture can be separated and removed at least in substantial part from the reagent gas, which does not become adsorbed on the composite adsorption media but passes through the composite adsorption media.

According to a different version of the method, the composite adsorption media can adsorb the reagent gas and one or more of the non-reagent gases, each being adsorbed by a different adsorbent material. Other non-reagent gases may be not adsorbed. After the reagent gas and one or more non-reagent gases are effectively adsorbed on the adsorption media, the reagent gas can be desorbed from the adsorption media under conditions that do not cause desorption of the one or more non-reagent gases, e.g., that cause no desorption of a non-reagent gas or that cause a small or minor amount of desorption of a non-reagent gas, e.g., less than 20, 10, or 5 percent of an adsorbed non-reagent gas may be desorbed. By these steps, the adsorbed and desorbed reagent gas can be separated at least in substantial part from the non-reagent gases of the exhaust gas mixture.

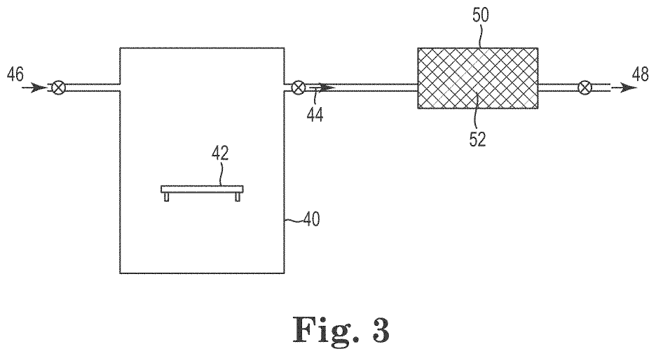

As illustrated at FIG. 3, tool 40, which contains substrate (semiconductor wafer or microelectronic device) 42, uses reagent gas 46 as a gaseous raw material. During the process performed by tool 40, not all of reagent gas will be used, e.g., an amount that is below 60, 50, 40, or 30 percent of a reagent gas delivered to the process may be effectively consumed by the process. Other gases may also be present or may be produced by the process. A result is exhaust gas mixture 44 leaving tool 40. The exhaust gas mixture contains a significant amount of the high value reagent gas, e.g., at least 5 and up to 50 or 60 percent of the un-used reagent gas species, e.g., from 10 to 40 percent un-used reagent gas by volume based on total volume of the exhaust gas. Depending on the cost of the reagent gas, recovering even a portion of the reagent gas from the exhaust gas for re-use may both reduce waste and reduce cost by re-using the high value (high cost) reagent gas.

One version of using a system of FIG. 3 is by use of a composite adsorption media as a flow-through filter, to remove non-reagent gases from the exhaust stream by adsorption, while the reagent gas does not adsorb but passes through the media. By this version, exhaust gas mixture 44 flows into housing 50, which contains composite adsorption media 52, which is effective to adsorb two or more different types of non-reagent gases within exhaust gas mixture 44. The composite adsorption media does not adsorb the reagent gas, which passes through the adsorption media as concentrated reagent gas 48 with fewer of the non-reagent gases, and at a higher concentration of the reagent gas. At least some amount of the two different non-reagent gases are adsorbed onto composite adsorption media 52, e.g., at least 50 percent, preferably a substantial amount or substantially all of each of the two non-reagent gases, such as at least 75, 90, or 95 percent of each of the two non-reagent gases contained in the exhaust gas mixture. The adsorbent adsorbs not more than a small or minor amount of the reagent gas, e.g., less than 10, 5, 2, or 1 percent of the total amount of reagent gas in exhaust gas mixture 44.

According to a different version of using a system of FIG. 3, the composite adsorption media 52 adsorbs the reagent gas species that is part of exhaust gas mixture 44. A second adsorbent is effective to adsorb an amount of one or more of the non-reagent gases. The of the reagent gas species that is adsorbed by the composite adsorbent media may be at least some of a reagent gas, e.g., at least 50 percent of an amount of reagent gas that is present in exhaust gas mixture 44. Preferably composite adsorbent media may adsorb a substantial amount or substantially all of an amount of reagent gases that is present in exhaust gas mixture 44, e.g., at least 75, 90, or 95 percent of the total amount of reagent gas present in exhaust gas mixture 44.

. After the reagent gas and the at least one non-reagent gas are effectively adsorbed on the adsorption media, the reagent gas can be desorbed from adsorption media 52 under conditions that do not cause desorption of the at least one non-reagent gas, e.g., that cause no desorption of a non-reagent gas or that cause a small or minor amount of desorption of non-reagent gas, e.g., less than 20, 10, or 5 percent of the total amount of adsorbed non-reagent gas may be desorbed.

Other flow control devices can be included in the system of FIG. 3, such as a flow meter, pressure valve, pressure regulator, pressure and temperature sensors, etc., but are not illustrated.

Composite adsorption media as described may be prepared by methods of additive manufacturing, including methods that are commonly referred to as “3-D printing” techniques. Different varieties of additive manufacturing techniques are known. Specific examples are those commonly referred to as “powder-bed” additive manufacturing methods, which include various “binder jet printing” techniques. Other examples include stereolithography techniques (SLS) and “feedstock dispensing methods” (FDMs). Composite adsorption media and related methods and materials are described herein in terms of these exemplary varieties, but preparing and using the described composite adsorption media can also be accomplished with other methods.

Example methods of preparing the described composite adsorption media involve additive manufacturing steps that individually and sequentially form multiple layers (e.g., “paths”) of solidified feedstock composition that contains at least two different types of adsorbent particles dispersed in solidified binder composition, with the solidified binder composition acting as a structure that holds the adsorbent particles together within the solidified feedstock composition. Using a series of additive manufacturing steps, the multiple layers of solidified feedstock are sequentially formed into a multi-layer composite adsorption media made from the layers of solidified feedstock.

The multi-layer composite adsorption media (or “composite adsorption media” or “composite” for short) contains two different types of adsorbent particles, each type being adapted to adsorb a gas component of a gas mixture. One of the two different adsorbents may be effective to adsorb a reagent gas and the other may be effective to adsorb a non-reagent gas, which may be an impurity. Alternately, the first adsorbent can be effective to adsorb a non-reagent gas such as an impurity, the second adsorbent can be effective to adsorb a different non-reagent gas such as a different impurity, and neither adsorbent will effectively adsorb the reagent gas, e.g., the composite adsorption media adsorbs less than 5, 2, or 1 percent of reagent gas that contacts the adsorption media.

As raw materials, the adsorbent particles are in particle form, such as a powder, and exhibit desired adsorption and desorption functionality. In the form of the composite adsorption media, however, the adsorbent particles have been combined with other materials. The multi-layer composite adsorption media that initially results from the additive manufacturing steps is a structure that may commonly be referred to as a “green body.” The multi-layer composite adsorption media in the form of a green body contains materials that are useful or required for the additive manufacturing steps, such as various components of a binder composition. Some materials of the composite adsorption media that were used to prepare the composite adsorption media but that are unnecessary for the desired functioning of the contained adsorbent particles, as adsorbent material, may be removed from the green body, or, alternately, may be otherwise processed to be further hardened or cured. Removing or processing those materials of the green body will improve the functioning of the two or more adsorbent particles as an adsorbent materials for use in methods and systems as described.

Thus, a composite adsorption media that is initially formed by an additive manufacturing technique may be further processed to remove solidified binder composition, to improve mechanical properties of the multi-layer composite adsorption media, or both. In example steps of processing the multi-layer composite adsorption media, the composite may be processed by any one or more of: a debinding step (to remove solidified binder or a portion thereof), by contact with solvent, by contact with a gas (e.g., for gas etching), or by exposing the composite to elevated temperature to cause the binder or the composite to be hardened, cured, or sintered.

For preparing a multi-layer composite adsorption media as described, certain types of additive manufacturing methods have been found to be useful or advantageous. Generally, additive manufacturing processes are known to be useful for preparing structures that exhibit a broad range of shapes and sizes. Additive manufacturing can also enable printing of complex microstructures, potentially with fine channels for enhancing gas penetration with controlled pressure drop. Additive manufacturing processes may also be highly automated and relatively efficient and cost-effective.

Additionally, certain types of additive manufacturing methods may be effective to produce a multi-layer composite adsorption media that retains useful functionality (e.g., as an adsorbent) of temperature-sensitive adsorbents such as MOF particles. By example additive manufacturing methods, a MOF adsorbent can be included as an adsorbent of a composite adsorbent media without the MOF becoming physically altered or “denatured” during the additive manufacturing step; preferred methods allow a MOF adsorbent, if present, to retain an original physical (chemical, molecular) form that allows the MOF to reversibly adsorb and desorb reagent gas, non-reagent gas, or an impurity.

To prevent denaturing of MOF adsorbent particles, i.e., to prevent physical, chemical, or molecular degradation of MOF molecules contained in MOF adsorbent particles and loss of desired functionality of MOF particles, preferred steps of preparing a multi-layer composite by an additive manufacturing technique may include steps that avoid exposing the MOF particles to a temperature that is 300 degrees Celsius or above, and may preferably not expose the MOF particles to a temperature that is greater than 250 or 200 degrees Celsius. Also, it may be desirable to prevent or minimize exposure of the MOF adsorbent particles to room air and moisture during the additive manufacturing process.

Additive manufacturing processes for forming a multi-layer composite adsorption media require ingredients that include at least two different types of adsorbent particles and one or more ingredients that combine to form a binder composition. The binder composition may be combined with the adsorbent particles, and the binder composition may be solidified (hardened, cured, or the like) to produce a solidified feedstock composition that contains solidified binder composition acting as a physical support structure (matrix) for the adsorbent particles. Steps of combining two or more adsorbent particles with the binder composition and causing the binder composition to solidify as a layer of a composite adsorption media may vary with different types of additive manufacturing techniques, e.g., steps of combining adsorbent particles with binder composition may be different for powder-bed techniques, and for different versions of powder-bed techniques, compared to stereolithography and feedstock dispensing methods. The ingredients of the binder composition may also be different for different types of additive manufacturing techniques.

In general, useful binder may include any material that is capable of being solidified as part of a feedstock composition, or by being added to a feedstock layer, to selectively form solidified feedstock at portions of a feedstock layer. Examples generally include organic materials such as polymers (e.g., synthetic polymers or natural polymers, either of which may optionally be chemically curable), inorganic materials such as clays and other inorganic particles, fugitive materials, etc.

One example of a type of material that can be useful as a binder composition (“binder”) or a component thereof is non-polymeric, inorganic particles such as a clay particles that can be suspended in a liquid and dried by removal of the liquid to form a solid material. A useful clay or other inorganic particle-type binder ingredient may be combined with two or more different types of adsorbent particles, and optional polymer, in a manner by which the inorganic particles and the adsorbent particles can become suspended together in a liquid (e.g., water, organic solvent, or a combination of both) followed by removal of the liquid, e.g., by evaporation. Upon removal of the liquid, the inorganic particles become part of a solidified binder composition that supports the adsorbent particles as part of a solidified feedstock composition.

Other binder compositions include curable polymeric binder materials. Curable polymeric binder in the form of a liquid may be combined with adsorbent particles in any manner. A feedstock layer may be formed from the liquid polymeric binder and adsorbent particles, with the binder being combined with the adsorbent particles before forming the feedstock layer or while forming the feedstock layer. The curable polymeric binder contained in the feedstock layer may be solidified. Examples of liquid binder materials include thermoplastic polymers that may be reversibly heated to form a liquid and then cooled to form a solid (e.g., may be reversibly melted and solidified). Alternately or additionally, a liquid polymeric binder material may be chemically curable, for example by exposure to elevated temperature (thermosetting) or by exposure to electromagnetic radiation such as from a laser, e.g., a UV laser.

Other examples of polymeric binders may be in the form of a liquid that contains liquid solvent. After the binder is combined with adsorbent particles, and applied as desired to form a feedstock layer, the solvent may be evaporated to leave the polymeric binder as a structure that supports the adsorbent particles. The polymer may optionally be subsequently cured by a chemical reaction that is initiated by heat (increased temperature), exposure to radiation, or by another reaction mechanism.

Curable liquid binder compositions may include curable materials that contain chemical monomers, oligomers, polymers, cross-linkers etc., and may additionally contain minor amounts of functional ingredients or additives that allow for or facilitate flow or curing of the curable binder composition. These may include any of: a flow aid, a surfactant, an emulsifier, a dispersant to prevent particle agglomeration, and an initiator to initiate cure of the polymer when exposed to electromagnetic (e.g., ultraviolet) radiation or an elevated temperature.

In additive manufacturing techniques referred to as “powder-bed” techniques, which include various techniques referred to as “binder-jet printing” techniques, adsorbent particles are contained in a bed of “feedstock” that can be formed into a uniform layer, known as a “feedstock layer.” The feedstock or feedstock layer contains one or more or two or more different types of adsorbent particles and may optionally include one or more additional ingredients such as one or more components of a binder composition. In some embodiments, the same feedstock is used in forming the feedstock layers and may contain both first adsorption media particles and second adsorption media particles. In other embodiments, multiple feedstock are used for example a first feedstock may have a first adsorption media and a second feedstock may have a second adsorption media different from the first adsorption media. In such instances, a first feedstock layer can be formed on a surface from the first feedstock, the first feedstock layer is solidified, and then a second feedstock layer is formed on the first feedstock layer from the second feedstock, and then the second feedstock layer is solidified, thereby creating a composite adsorption media with alternate layers having different adsorption media. In such embodiments, the feedstock for the first feedstock layer may include one of the first adsorption media particles and the second adsorption media particles (but not both) and the feedstock for the second feedstock layer comprises the other of the first adsorption media particles and second adsorption media particles. Example binders may include a first binder component as part of a feedstock, and a second binder component that is a liquid component that is part of a liquid that is selectively dispensed onto a feedstock layer. As a binder component that is part of a dry feedstock powder, the amount of binder contained in a feedstock powder may be, for example, at least 20 percent or at least 30 percent by volume of the total volume of the feedstock, e.g., when formed as a feedstock layer (this volume percentage is a “bulk” volume percentage based on total volume of the feedstock material, including void space; i.e., volume of binder per total volume of a feedstock layer including void space).

These methods cause a binder composition, one or more components of which may be included in the feedstock layer or selectively applied to portions of the feedstock layer, to solidify to form a solidified binder composition at selected portions (areas) of the feedstock layer. The mechanism by which the binder composition (or separate portions thereof) becomes located at the selected portion of the feedstock layer, and the mechanism by which the binder composition at the selected portion of the feedstock layer becomes solidified, may vary.

Powder-bed additive manufacturing technique can involve, in general terms, a sequence of multiple individual layer-forming steps, each step being used to form a single cross-sectional layer of a multi-layer composite adsorption media. After forming a first (bottom) layer, each subsequent layer is formed on a top surface of a preceding layer. This series of multiple individual layer-forming steps is effective to form a multi-layer composite adsorption media of multiple individually-formed layers of solidified feedstock.

These techniques, like other additive manufacturing techniques, produce objects that are described or defined by digital data such as a CAD (computer-aided design) file. A three-dimensional object is sequentially built up, layer-by-layer, using a series of individual steps that combine to produce a composite body (“multi-layer composite adsorption media”) made of many thin cross sectional layers of solidified feedstock. Each layer-forming step may include forming on a surface a single feedstock layer that includes feedstock that contains two different types of adsorbent particles. In some example methods, the feedstock layer may contain binder composition or a component thereof. In other example methods, a feedstock layer does not contain binder composition or a component of a binder composition; in these methods the binder composition is selectively added to portions of the feedstock layer.

By one example, a roller or other spreading device uniformly applies an amount of a feedstock composition in the form of a powder over a surface, either by applying a single amount of a powder feedstock composition in a single pass, or by applying multiple separate amounts of powder feedstock with multiple passes over the surface. The “feedstock layer” may be formed from a feedstock composition by one or multiple steps of applying a powder feedstock composition to the surface and using a roller or other application method to form a smooth, uniform feedstock layer having a desired and useful depth.

A useful depth (thickness) of a feedstock layer can depend on various factors such as particle size of adsorbent particles in the feedstock layer, desired properties (quality, e.g., surface finish, layer density, dimensional accuracy) of a solidified feedstock layer, and the resolution of a printhead or other device used to apply a liquid material to the feedstock layer. Desirably, a feedstock layer thickness may be at least 2 or 3 times a diameter (D50) of the largest adsorbent particles in the feedstock. A typical thickness of a useful feedstock layer may be in a range from 25 microns to 200 microns.

After forming a feedstock layer, portions of the feedstock layer are selectively processed to form solidified feedstock layer. Following these steps to form solidified feedstock composition, an additional thin layer of the powder feedstock composition is spread over the top surface of the completed layer, which contains the solidified feedstock surrounded by an amount of non-solidified (original) feedstock composition.

The process is repeated to form multiple layers that contain the solidified feedstock, with each new layer (after the first layer) of solidified feedstock being formed on and adhering to a previous layer of the solidified feedstock. Multiple feedstock layers are deposited and multiple layers of solidified feedstock are formed, successively, one over each completed layer, to form the multi-layer composite adsorption media. After all layers of the multi-layer composite adsorption media have been deposited, the portions of the feedstock layers that contain the original feedstock material that has not been used to prepare solidified feedstock may be separated away from the multi-layer composite adsorption media.

If desired or useful, a feedstock layer used in a powder bed additive manufacturing technique may contain one or more optional ingredients that are either part of a binder composition or otherwise useful as part of the solidified feedstock layer. These may include, for example, a flow aid to improve flow of the feedstock within the printer bed, to improve the ability of the feedstock to form an even (uniform, level, homogeneous) feedstock layer. Alternately or in addition, the feedstock layer may optionally contain solid polymer material that acts as a spacer between the adsorbent particles, e.g., that acts as a “pore-forming” material. Such a solid polymer may be a thermoplastic (in solid form at room temperature) pore-forming polymer, and may be present in the feedstock layer in any desired amount, such as in an amount of from 0.5 to 15 weight percent based on total weight feedstock, e.g., from 1 to 12 or from 2 to 10 weight percent based on total weight feedstock.

In more detail, one specific example of a powder-bed technique is referred to as “jet binder printing.” In these methods, the feedstock layer contains the two or more different types of adsorbent particles and may or may not include binder composition or a component of a binder composition.

The solidified feedstock layer is formed by selectively applying a liquid material (considered a binder or a binder component) to portions of the feedstock layer to selectively form solidified feedstock composition at those selected portions of the feedstock layer. A printhead or other device that is effective to selectively dispense and apply a desired amount of the liquid to the portions of feedstock layer moves over the upper surface of the feedstock layer. The printhead or other useful device ejects the liquid and applies the liquid at selected portions of the top surface of the feedstock layer. The liquid flows into the feedstock layer and is useful to form solidified binder composition at the locations of the feedstock layer at which the liquid is selectively applied. The solidified feedstock composition contains the adsorbent particles dispersed throughout the solidified binder composition. Portions of the feedstock layer that are not contacted with the liquid remain as non-solidified feedstock and can subsequently be separated from the solidified feedstock composition.

Within this general description of jet binder techniques, different variations also exist. According to one variation, the feedstock layer contains a dry powder feedstock composition that contains the adsorbent particles and a binder composition or portion of a binder composition, and the liquid that is selectively applied to the feedstock layer is a liquid that is useful in a step of causing the binder composition or component thereof in the feedstock layer to solidify. With more exemplary detail, but without limiting the present description, this type of method may use dry (powder) feedstock that contains adsorbent particles and a component of a binder composition that will become dissolved, suspended, or otherwise activated and solidified when contacted with the ejected liquid, after which the combined binder composition may become solidified as a matrix surrounding the adsorbent particles.

The component of the binder composition that is included in the feedstock may be organic, such as a polymer (e.g., polyvinyl alcohol) or a phenolic resin, or may be inorganic, such as an inorganic particle such as clay (e.g., bentonite clay). The liquid that is applied to the feedstock layer may be a liquid that is effective to dissolve, disperse, chemically react with, or otherwise solidify the binder composition or binder component that is initially present in the feedstock layer. In some examples, the liquid or a portion of the liquid may subsequently be removed (e.g., evaporated) to leave behind a solidified feedstock composition that includes solidified binder composition as a matrix structure that surrounds and supports the adsorbent particles.

In a particular jet binder printing system, a feedstock may be a dry powder form feedstock that contains two different types of adsorbent particles (e.g., a combination of at least two of zeolite, MOF, or carbon adsorbent particles), and binder in the form of inorganic particles such as clay (e.g., bentonite clay). The clay may be present in the feedstock in a useful amount, such as from 3 to 20 weight percent clay, e.g., from 5 to 15 weight percent clay, based on total weight feedstock. The clay binder may be solidified by contacting the clay binder with water, e.g., deionized water, which may be selectively applied to a portion of the feedstock layer using a printhead or other dispensing device of a 3D printing apparatus. Multiple layers of feedstock are formed in this manner, sequentially, by forming a feedstock layer and causing a selected portion of the feedstock layer to solidify by contacting the feedstock layer with the deionized water.

A resulting multi-layer green body is produced, which is surrounded by loose (non-solidified) feedstock. Advantageously, by using water as a liquid to solidify the binder, the green body contains water as part of the binder to hold together the adsorbent particles of the solidified feedstock. The water can be frozen to increase the strength of the green body for a step of separating the green body from the non-solidified powder feedstock.

In a specific example of useful steps, a multi-layer green body can be formed from multiple layers of feedstock that contains at least two different types of adsorbent, and clay. The feedstock may contain, comprise, or consist of the at least two different types of adsorbent, and clay. The feedstock may contain from 5 to 20 weight percent clay (e.g., bentonite clay), from 80 to 95 weight percent adsorbent particles (at least two different types), and less than 20, 10, or 5 weight percent of any other materials.

The feedstock layers are formed from the feedstock powder and are selectively contacted with water to solidify the clay; portions of a feedstock layer that are not solidified remain dry and in the form of loose feedstock. After multiple layers of solidified feedstock are formed to produce a multi-layer green body, the green body and surrounding non-solidified feedstock can be placed at a reduced temperature (e.g., between negative 2 (−2) and negative 10 (−10) degrees Celsius) to freeze the water contained in the green body. After the water is frozen, the green body can be separated from the surrounding loose power mechanically, including by optionally using a brush to remove powder particles from the surface of the frozen green body. The un-used (non-solidified) feedstock can be re-used.

The green body may next be sintered. Preferably, after separating the green body from the non-solidified feedstock, the green body will be moved to a location to perform a sintering step, and the step of sintering the will be started promptly, while the green body remains frozen, at a temperature below zero degrees or below negative 2 (−2) degrees Celsius.

As a different variation of a powder-bed additive manufacturing technique, a feedstock layer does not contain (or does not require) any ingredient that is part of a binder composition. In this variation, the liquid that is selectively applied to the feedstock layer may include all necessary ingredients of a binder composition, which may be in the form of a thermoplastic or chemically curable polymer, in liquid form. In this variation, the liquid binder composition is selectively applied to the feedstock layer and is allowed or caused to solidify in place to produce the solidified feedstock layer.

According to examples of this type of a system, the feedstock layer may contain adsorbent particles and need not contain any other material. E.g., the feedstock layer may contain at least 70, 80, 90, or 95 percent by weight of the two or more types of adsorbent particles. Other ingredients in the feedstock layer may be useful, however, such as pore-forming particles, flow aids, and the like, as described herein.

The liquid binder composition that is applied to the feedstock layer can include all ingredients of a binder composition that are necessary to selectively dispense and apply the binder composition in liquid form to the feedstock layer, and also for the liquid binder composition to become solidified as part of a solidified feedstock composition. The liquid binder may, for example, contain polymeric material that can be solidified by any of a chemical curing mechanism (by exposure to electromagnetic radiation), by a reduction in temperature, or by removal of solvent by evaporation. The liquid binder composition can include the curable polymer in combination with useful amounts of additives such as organic solvent, a flow agent, or a surfactant, that causes the liquid binder to have flow and surface tension properties that allow the liquid binder to effectively interact with the particles of the feedstock layer, to produce a desired solidified feedstock layer. A useful organic solvent, flow agent, or surfactant may be selected based on the hydrophilic or hydrophobic nature of the particles of the feedstock.

Yet another variety of an additive manufacturing technique is referred to as stereolithography. This method uses steps and equipment similar to powder-bed techniques. By these techniques, the feedstock layer contains MOF particles dispersed in a curable liquid binder composition. The liquid feedstock layer can be contained in a shallow bed, as with binder jet techniques. Multiple layers of solidified feedstock composition are successively formed by each layer being selectively cured (solidified) by exposure to electromagnetic radiation such as ultraviolet (UV) radiation. Compared to selectively applying liquid to a powder feedstock layer to cause the feedstock layer to solidify (as described supra with respect to jet binder techniques), stereolithography techniques selectively solidify (cure) portions of a liquid feedstock layer by exposing those portions of the feedstock layer to electromagnetic radiation, which induces chemical curing.

Yet another additive manufacturing technique that may be useful as described herein is referred to as “selective laser irradiation” or “SLI.” This process is similar to stereolithography but instead of a liquid curable feedstock used in stereolithography, a selective laser irradiation method uses a feedstock that contains binder in the form of a solid material, e.g., a powder, in combination with adsorbent particles. The binder may be a thermoplastic or a radiation-curable polymer. If a thermopolymer, the binder can be heated by the laser to melt and can then cool to become re-solidified as solidified feedstock. Alternately, solid (powder) binder contained in the feedstock may be include radiation-curable polymer that is caused to react and polymerize when irradiated by the laser to form solidified feedstock.

In addition to powder-bed and stereolithography additive manufacture techniques, other additive manufacturing techniques may also be useful to prepare a multi-layer adsorbent composition media also include non-powder-bed techniques. One example is referred to as the “feedstock dispensing method” (FDM). By this technique, no feedstock layer is prepared within a bed and later selectively solidified by selective contact with a liquid (by jet binder techniques) or selective irradiation (stereolithography). Instead, a flowable (liquid) feedstock material that contains both adsorbent particles and binder composition is selectively applied to a surface as a path or layer, with multiple successive applications forming a series of successive layers of the solidified feedstock composition.

The feedstock may contain a binder as described herein, which may be polymeric (e.g., curable or thermoplastic), inorganic (e.g., inorganic particles), etc. If the binder contains radiation-curable polymer, the feedstock may be solidified by exposing the binder to electromagnetic radiation. If the binder is inorganic, the feedstock may be solidified by exposure to elevated temperature, e.g., to remove solvent.

The feedstock that is selectively applied to the surface, e.g., by ejection through a printhead or other effective device, contains all components of the solidified feedstock layer. The binder composition of the liquid feedstock material may, for example, contain polymeric material that can be solidified by a chemical curing mechanism such as by exposure to light or irradiation, exposure to elevated temperature, or alternately by removal of solvent from the liquid feedstock material. In other examples, the binder composition of the liquid feedstock material may be a thermoplastic material that is heated above a melting temperature to be formed as a path or layer of feedstock and is subsequently cooled to produce the solidified feedstock composition. Example feedstock compositions can contain a binder component and polymer, and is a flowable material that may be considered a semi-solid feedstock or a viscous liquid.

Each of these different types of additive manufacturing techniques described herein for use in preparing a multi-layer composite adsorption media will require a binder composition, at least two different types of adsorbent particles (e.g., in the form of a powder or collection of particles), and useful equipment for carrying out the additive manufacturing steps. The equipment may be an automated 3D printer that is capable of forming the composite adsorption media by a powder bed technique (generally), a jet binder printing technique, a stereolithographic printing technique, a filament deposition method, or another useful additive manufacturing method. Useful equipment and related methods will be effective to place multiple layers of solidified feedstock, sequentially, one over a preceding layer, to form the multi-layer composite adsorption media. Importantly, when a feedstock contains MOF adsorbent particles, the method of preparing the multi-layer composite adsorption media can be selected to avoid any processing that would cause the MOF adsorbent particles to become ineffective as an adsorbent material, e.g., by physical or chemical degradation, such as due to exposure to high temperature.

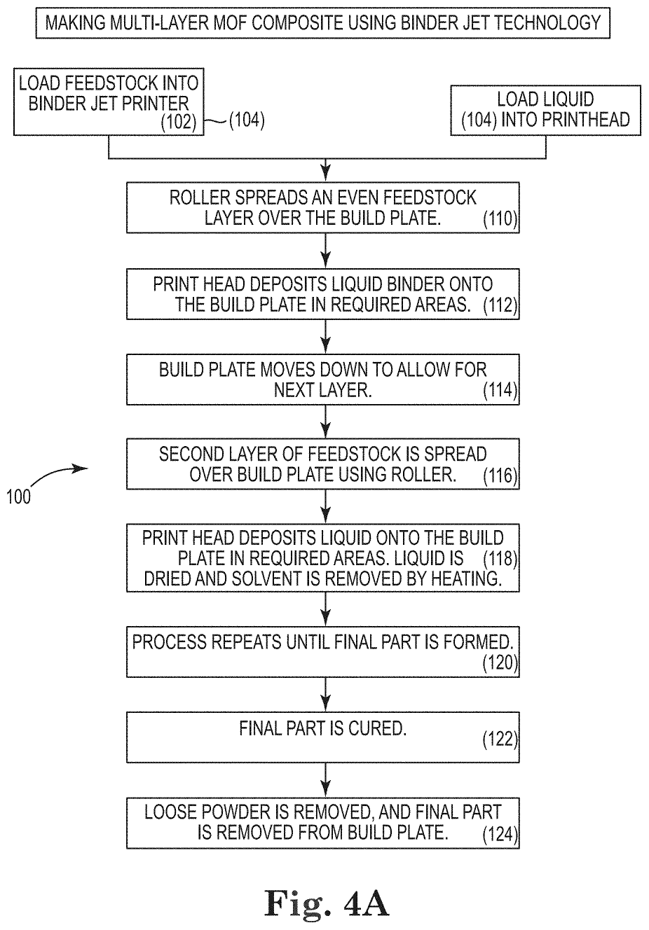

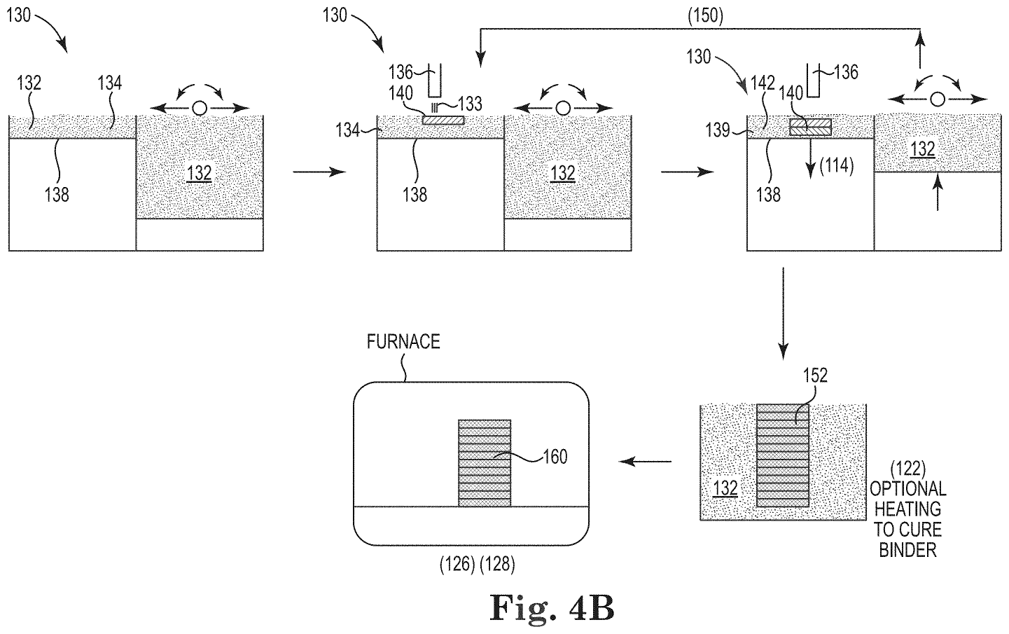

Examples of a binder jet printing additive manufacturing technique (100) useful for preparing a multi-layer composite adsorption media are shown at FIGS. 4A and 4B.

FIG. 4A illustrates a sequence of steps of a useful binder jet printing additive manufacturing technique, and identifies that the method can be used, independently, with different forms of feedstock 102 loaded at a printer bed of an additive manufacturing system, and with different liquids 104 loaded at a printhead of the additive manufacturing system.

Feedstock 102 is a powder that contains at least two different types of adsorbent particles, and optional additional ingredients. In example methods, feedstock 102 does not contain binder composition or a component thereof (e.g., does not require binder composition or a component thereof), and liquid 104 contains binder composition. In other example methods, feedstock 102 does contain binder composition or a component of binder composition, and liquid 104 contains a liquid ingredient that is effective to cause the binder composition in the feedstock to solidify.

The following describes a system and method by which a binder composition that contains curable polymeric material or a binder component such as water is ejected from the printhead onto selective portions of a feedstock layer to effect solidification of the selected portions of the feedstock layer. The process can be performed using commercially available binder jet printing apparatus, combinations of two or more adsorbent particles as described herein, and with liquid polymeric binder or a binder component such as water (104) dispensed from a printhead of the apparatus.

According to example steps of the method (FIG. 4A), dry (powder) feedstock (102) is loaded into a bed of a powder-bed additive manufacturing system and is formed as an even feedstock layer of a desired depth over a build plate of the apparatus (110). In a subsequent step (112), a print head selectively deposits liquid binder or a component of a binder system (104) onto a portion of the first layer. The liquid binder (104) may be solidified after being placed onto the feedstock layer. For example, liquid binder (104) may contain polymer that is dissolved or dispersed in a liquid solvent that can be removed to cause the polymer to solidify. Alternately, the feedstock may contain a binder component such as clay, and the liquid binder component (104) such as water (e.g., distilled water) may cause a binder component of the feedstock, e.g., clay, to solidify.

After the liquid binder (104) is selectively applied to the feedstock layer, the liquid binder (104) can be solidified, e.g., by applying heat to the liquid binder to remove solvent from the binder and form solidified feedstock at the portion. Alternately, liquid binder (104) may be a thermoplastic that can be melted, applied to the feedstock layer, and then cooled to solidify. Alternately, the liquid binder (104) may be a curable polymer that can be applied to the feedstock layer in liquid form and then reacted chemically to solidify. Alternately, the liquid may be a binder component such as water (104) that can be applied to the feedstock layer, which contains a second binder component such as inorganic particles, and the liquid and inorganic particles solidify to form solidified feedstock.

The liquid binder is applied to the feedstock layer in an amount that is effective to fix the positions of the adsorbent particles of the feedstock layer. The method does not require that the liquid binder be applied in an amount or manner to fill spaces between the adsorbent particles of the feedstock, but may be applied in an amount that connects or “bridges” adjacent or nearby particles in the powder feedstock layer to cause the positions of the particles to be fixed relative to other adsorbent particles, without necessarily filling void spaces of the feedstock layer. The “solidified” feedstock is “solid” in a sense of being stiffened, rigid, or hardened sufficiently to act as a structure that supports and maintains the positions of the adsorbent particles, but may also contain openings, void spaces, or pores between the connected particles. The solidified feedstock, for example, may include adsorbent particles that are connected by a dried, cured, or otherwise continuous (but not necessarily solid, meaning without pores or inter-particle spaces) polymeric material that connects and maintains the position of adsorbent particles within the solidified feedstock structure.

Portions of the feedstock layer as applied, that are not formed to solidified feedstock, remain as the original powder feedstock.

The build plate is moved down (114) and a second layer of the feedstock is formed (116) as a second even feedstock layer over the first feedstock layer, which includes a portion of solidified feedstock. The print head then selectively deposits a second amount of the liquid polymeric binder or binder component (104) onto portions of the second feedstock layer (118), and the second amount of the liquid binder or binder component (104) and binder form solidified feedstock from the second layer, e.g., by using heat to remove solvent and form dry (solidified) polymeric binder, or by another relevant mechanism based on the type of binder composition.

Portions of the second layer that are not formed to solidified feedstock remain as the original powder feedstock.

Steps 114, 116, and 118 are repeated (120) to form a completed multi-layer composite adsorption media (green body) that is surrounded by the original powder feedstock (1024). The multi-layer composite adsorption media is a multi-layer body that contains the solidified feedstock of each formed layer and is composed of the adsorbent particles of the feedstock dispersed in the solidified (solid) binder. Optionally, the multi-layer composite adsorption media, optionally in the presence of the surrounding original powder feedstock, can be heated to crosslink and cure the liquid polymeric binder (122), if the polymeric binder is thermally curable. The original (loose) powder feedstock (102 or 104) can be removed and separated from the multi-layer composite (124). Alternately, for a binder that contains water, the green body multi-layer composite adsorption media, optionally in the presence of the surrounding original powder feedstock, can be frozen to strengthen the green body.

The multi-layer composite can be moved to a location for any subsequent type of processing that may be useful or desired to convert the green body form of a finished, completely processed composite adsorption media.

FIG. 4B schematically illustrates steps of technique 100 with related process equipment and feedstock. Referring to FIG. 4B, an example process can be performed using commercially available binder jet printing apparatus (130), feedstock (132) as described herein that contains at least two different types of adsorbent particles, and liquid (133) dispensed from a printhead (136) of the apparatus (130). According to example steps of the method, feedstock (132) is formed as an even thickness and level feedstock layer (134) over a build plate (138) of the apparatus (130). Feedstock layer (134) may be formed using a roller or other leveling device, using one pass or multiple passes to uniformly form and distribute a desired depth of feedstock (132). Print head (136) selectively deposits liquid (133) onto a portion of the first layer (134).

Liquid 133 may be, for example, a liquid binder composition (as described relative to FIG. 4A) or may be another liquid as described herein, e.g., water. The liquid (133), in the form a liquid binder composition, may be solidified, e.g., by drying with heat to evaporate solvent of the binder and form a first solidified feedstock (140) containing solid polymer at the portion. Alternately, the liquid 133 may be a binder component such as water (104) that can be applied to the feedstock layer, which contains a second binder component such as inorganic particles, and the liquid and inorganic particles solidify to form solidified feedstock.

Portions of feedstock layer 134 that are not formed to solidified feedstock (140) remain as the original powder feedstock (132). The build plate (136) is moved down (114) and a second or subsequent feedstock layer (142) is formed over the first layer (134) and the first solidified feedstock (140). The print head (136) then selectively deposits a second amount of the liquid (133) onto portions of the second layer (142) and the second amount of the liquid polymeric binder (133) forms solidified feedstock from the second layer. Portions of the second layer that are not formed to solidified feedstock remain as the original powder feedstock.

This sequence of steps of applying a feedstock layer over a previous layer and applying liquid 133 to the new feedstock layer to produce solidified feedstock of the new feedstock layer is repeated (150) to form a completed multi-layer composite adsorption media (e.g., as a green body) (152) surrounded by the original powder feedstock (132). The multi-layer composite adsorption media (152) is a body that contains the solidified feedstock of each formed layer and is composed of the at least two different types of adsorbent particles from the feedstock dispersed in the solidified (solid) polymer binder. As desired, the multi-layer composite adsorption media can be further processed to convert the green body form of the composite adsorption media into a useful adsorbent material that will perform as a composite adsorption media in a method that is described herein.

In an example subsequent processing step, as illustrated, the multi-layer composite adsorption media (152), optionally in the presence of the surrounding original powder feedstock (132), can be heated to cure the liquid polymeric binder (122). Alternately, for a liquid (133) that contains water, the green body multi-layer composite adsorption media, optionally in the presence of the surrounding original powder feedstock, can be frozen to strengthen the green body

The original (loose) powder feedstock (132) can be removed and separated from the multi-layer composite adsorption media (152). The multi-layer composite (152) can be moved to an oven for heating to a temperature that will be effective to remove solidified binder (a “debind” or “debinding” step) from the multi-layer composite (152).

The additive manufacturing technique referred to as stereolithography (SLA) is a version of additive manufacturing technology that, as now appreciated by the present Applicant and as described herein, can be used to form a multi-layer composite adsorption media in a layer-by-layer fashion, and using photochemical processes by which light (electromagnetic radiation) is used to selectively cause chemical monomers and oligomers (together referred to as “polymer” or “liquid polymer binder”) of a layer of liquid feedstock to polymerize, cross-link, or otherwise react chemically to form a cured polymeric reaction product (“solidified polymer”) of solidified feedstock of a feedstock layer. The liquid polymer binder is selectively curable by exposure to electromagnetic radiation such as ultraviolet (UV) light. The feedstock is in liquid form and contains curable liquid polymer (“liquid polymer binder”) in combination with at least two different types of adsorbent particles.

The multi-layer composite adsorption media is built by sequential steps of producing many thin cross sections (“solidified feedstock” of a “layer,” herein) that together form a larger three-dimensional structure (composite adsorption media). A source of electromagnetic radiation (e.g., a laser) selectively applies electromagnetic radiation over a portion of a layer of the liquid feedstock, which according to the present invention contains at least two different types of adsorbent particles along with liquid polymer binder that can be solidified by chemically curing upon exposure to the electromagnetic radiation. The laser selectively irradiates a portion of the layer of the liquid feedstock at a surface of the layer. The electromagnetic radiation causes the liquid polymer binder to solidify by a chemical reaction (i.e., to cure) to form solidified feedstock that contains the two or more different types of adsorbent particles and solidified (cured) polymer.

After an initial layer of solidified feedstock is formed, an additional thin layer of the liquid feedstock is deposited over the top surface of the completed layer that contains the solidified feedstock, and the process is repeated with multiple layers being formed on and adhering to a top surface of a previous layer. Multiple layers are deposited, successively, one over each completed layer, to form a multi-layer composite adsorption media that is a cohesive assembly of each of the individually-formed layers of solidified feedstock. After all layers of the multi-layer composite adsorption media have been formed, portions of the layers that contain original liquid feedstock that has not been used to prepare solidified feedstock are separated from the multi-layer composite adsorption media. The multi-layer composite adsorption media can be subsequently processed as desired to form a derivative structure, such as a final composite adsorbent media useful in a method as described herein to separate gases of a gas mixture. subsequent processing may include, for example, steps of removing the solidified (cured) polymer from the MOF particles (i.e., “debinding”).

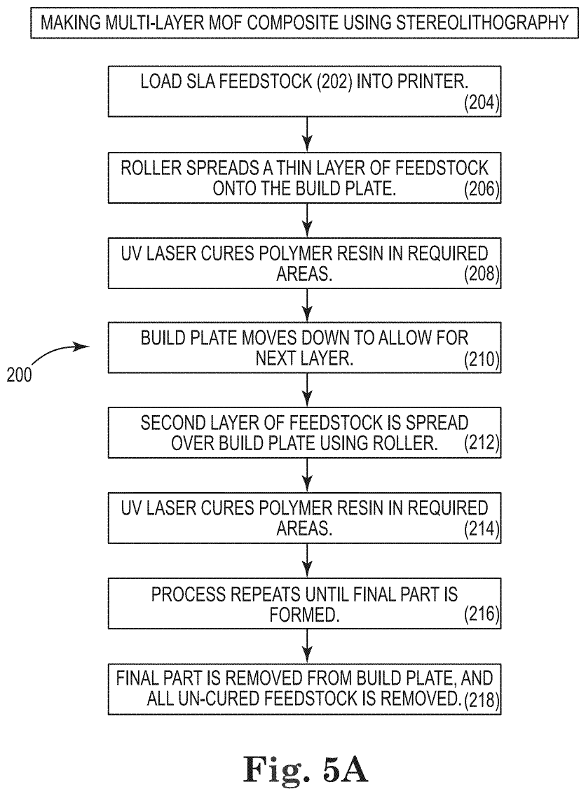

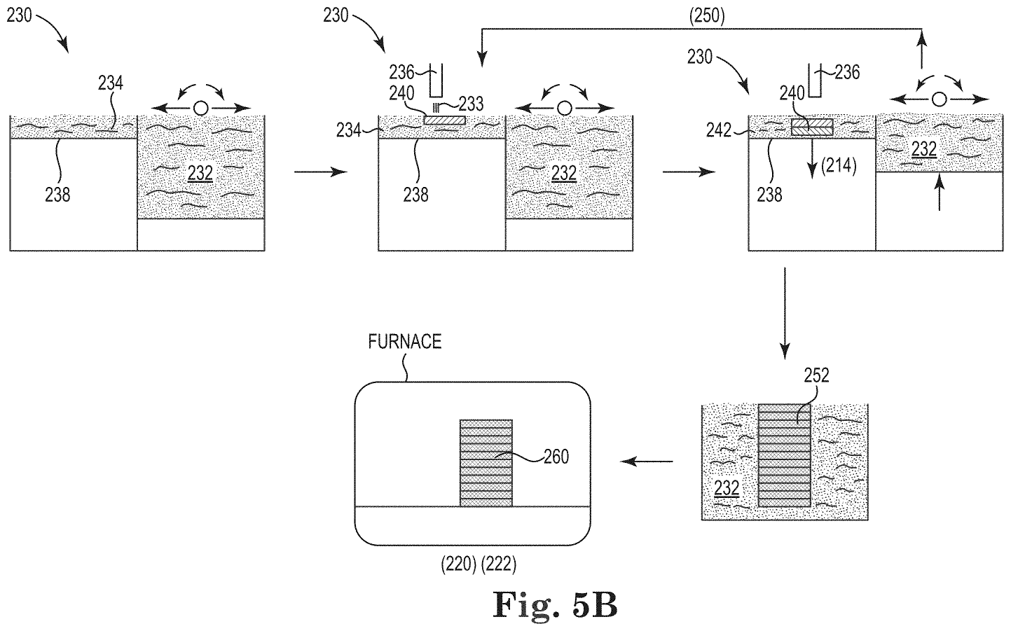

An example of a stereolithography additive manufacturing technique (200) useful for preparing a multi-layer composite adsorption media as described herein is shown at FIG. 5A. Feedstock 202 is a liquid that contains at least two different types of adsorbent particles in combination with a liquid curable polymer binder.

The process can be performed using commercially available stereolithography additive manufacturing equipment and feedstock that contains liquid polymeric binder combined with the two or more different types of adsorbent particles. According to example steps of the example method (as shown at FIG. 5A, with steps numbered parenthetically), liquid feedstock (202) contained by an SLA additive manufacturing apparatus is formed as an even layer over a build plate of the apparatus (204, 206). In a subsequent step (208), a source of electromagnetic radiation (e.g., a UV (ultraviolet) laser) selectively irradiates a portion of this first layer with radiation of a wavelength that will chemically cure and solidify the liquid polymer binder of the feedstock. The solidified liquid polymer binder forms solidified feedstock at the irradiated portion.

Portions of the layer that are not formed to solidified feedstock remain as the original liquid feedstock.

The build plate is moved down (210) and a second layer of the liquid feedstock is formed (212) as a second even layer over the first feedstock layer and over the solidified feedstock of the first feedstock layer. The source of electromagnetic radiation then selectively irradiates a portion of the second layer (214) to solidify (cure) a portion of the second layer of liquid feedstock to form solidified feedstock at portions of the second layer. Portions of the second layer that are not formed to solidified feedstock remain as the original liquid feedstock. Steps 212, 214, and 216 are repeated (218) to form a completed multi-layer solidified feedstock composite (“final part”) surrounded by the original liquid feedstock (202).

The multi-layer solidified feedstock composite is a body that contains the solidified feedstock of each formed layer and is composed of the two or more different types of adsorbent particles dispersed in the solidified (solid) polymer binder of the liquid feedstock. The original liquid feedstock (202) can be removed and separated from the multi-layer composite (218). The multi-layer composite adsorption media can then be further processed to form a derivative structure, such as a MOF-type adsorbent material.

Referring to FIG. 5B, an example process can be performed using commercially available SLA apparatus (230) and using liquid feedstock (232) according to the present description. According to example steps, liquid feedstock (232) is formed as an even feedstock layer (234) over a build plate (238) of the apparatus (230). Laser (236) applies electromagnetic radiation (233) to a portion of the first layer (234) to form first solidified feedstock (240) at the portion. Portions of feedstock layer (234) that are not formed to solidified feedstock (240) remain as the original liquid feedstock (232). The build plate (238) is moved down (214) and a second or subsequent liquid feedstock layer (242) is formed over the first layer (234) and the first solidified feedstock (240). The laser (236) then selectively applies electromagnetic radiation (233) to portions of the second layer (242) to form solidified feedstock from the second layer. Portions of the second layer that are not formed to solidified feedstock remain as the original liquid feedstock. The sequence is repeated (250) to form a completed multi-layer solidified feedstock composite (252) surrounded by the original liquid feedstock (232). The multi-layer solidified feedstock composite (252) is a body that contains the solidified feedstock of each formed layer and is composed of the two different types of adsorbent particles from the feedstock dispersed in solidified (solid) cured polymer of the feedstock.

The original liquid feedstock (232) can be removed and separated from the multi-layer composite (252). The multi-layer composite (252) can then be further processed to form a derivative structure, such as a composite adsorption media that is useful in a process as described herein of separating gases of a gas mixture.

As an example of an additive manufacturing method that also uses a powder bed, and comparable steps, a technique referred herein as selective laser irradiation (SLI) can be used to form a multi-layer composite adsorption media in a layer-by-layer fashion. Selective laser irradiation uses laser energy to selectively cause portions of a feedstock layer to solidify.

More specifically, a multi-layer composite may be built by sequential steps of producing many thin cross sections (“solidified feedstock” of a “layer,” herein) of a larger three-dimensional structure (composite body). A layer of solid (e.g., powder) feedstock is formed to include at least two different types of adsorbent particles, as described, in combination with polymeric binder, for example with these ingredients being combined to form a powder (not a liquid). Laser energy is selectively applied to the feedstock layer over a portion of the layer. The laser energy causes the polymeric binder to solidify at the portions of the feedstock that are exposed to the laser energy. The particles may solidify by being heated and melted by the laser energy, then re-solidifying, or by a chemical reaction that is initiated by the laser energy.

After an initial layer of solidified feedstock is formed in this manner, an additional thin layer of the feedstock is deposited over the top surface of the completed layer that contains the solidified feedstock. The process is repeated to form multiple layers of the solidified feedstock, each layer being formed on top of and adhering to a top surface of a previous layer. Multiple layers are deposited, successively, one over each completed layer, to form a multi-layer composite that is a composite of each layer of solidified feedstock. The multiple layers may be of the same composition and thickness, or may be of different compositions and different layer thicknesses.

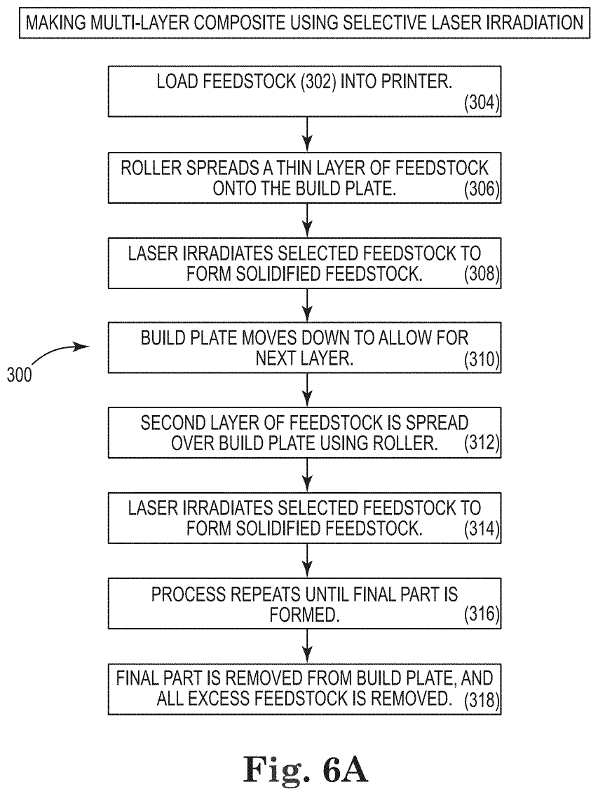

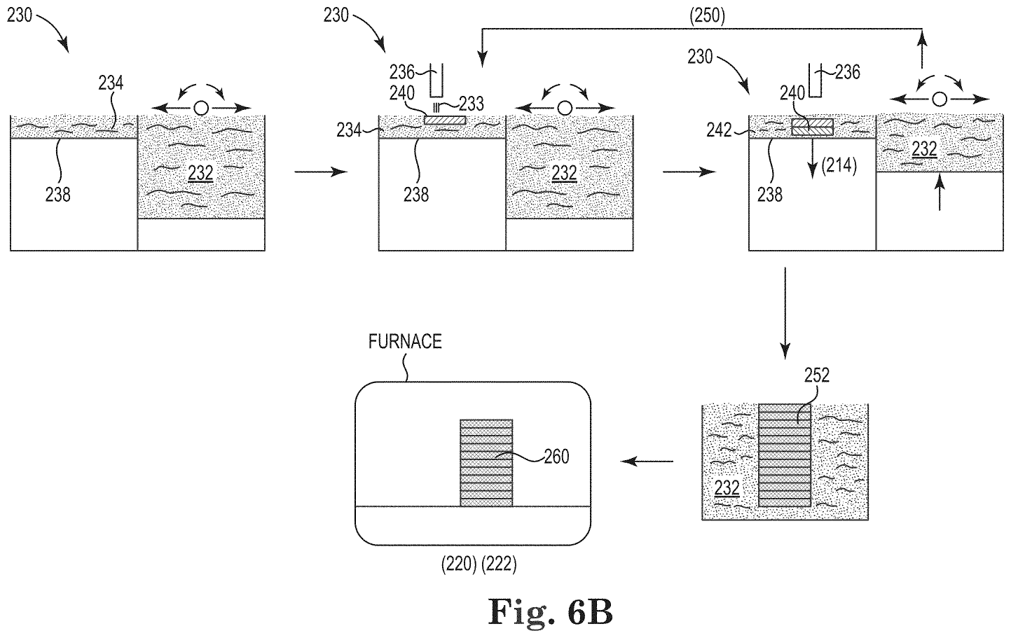

An example of a selective laser irradiation additive manufacturing technique (300) useful for preparing a multi-layer composite as described is shown at FIG. 6A. The process can be performed using commercially available additive manufacturing equipment and binder and particles to form feedstock. Feedstock 302 contains a collection of adsorbent particles, including at least two different types of adsorbent, and binder that includes radiation-curable binder. According to example steps as shown at FIG. 5A, feedstock (302) contained by an additive manufacturing apparatus is formed as an even layer over a build plate of the apparatus (304, 306). In a subsequent step (308), a source of electromagnetic radiation (e.g., a laser) selectively irradiates a portion of this first layer of feedstock with radiation of a wavelength and energy that will cause the binder of the feedstock to react and harden (“solidify”). The solidified binder and MOF particles form solidified feedstock at the irradiated portion. Portions of the feedstock layer that are not formed to solidified feedstock remain as the original liquid feedstock.

The build plate is moved down (310) and a second layer of the feedstock is formed (312) as a second even layer over the first feedstock layer and over the solidified feedstock of the first feedstock layer. The source of electromagnetic radiation then selectively irradiates a portion of the second layer (314), which causes polymer of the feedstock at the portion to solidify to form solidified feedstock at the portions of the second layer. Portions of the second layer that are not formed to solidified feedstock remain as the original powder feedstock. Steps 312, 314, and 316 are repeated (318) to form a completed multi-layer solidified feedstock composite surrounded by the original feedstock (302).

The multi-layer solidified feedstock composite is a body that contains the solidified feedstock of each formed layer, and is composed of multiple continuous layers made from the material of the reacted polymeric binder and MOF particles of the feedstock. The original feedstock (302) can be removed and separated from the multi-layer composite (318).

Referring to FIG. 3B, an example process can be performed using commercially available additive manufacturing apparatus (330), and feedstock (332) in the form of a powder that contains curable polymeric binder and two or more different types of adsorbent particles according to the present description. According to example steps of the method, feedstock (332) is formed as an even feedstock layer (334) over a build plate (338) of the apparatus (330). Laser (336) applies electromagnetic radiation (333) to a portion of the first layer (334), which causes radiation-curable polymer of the feedstock to react and form solidified feedstock (340) at the portion. Portions of feedstock layer (334) that are not formed to solidified feedstock (340) remain as the original feedstock (332). The build plate (338) is moved down (314) and a second or subsequent feedstock layer (342) is formed over the first layer (334) and the first solidified feedstock (340). The laser (336) then selectively applies electromagnetic radiation (333) to portions of the second layer (342), causing radiation-curable polymer of the feedstock to form solidified feedstock from the second layer. Portions of the second layer that are not formed to solidified feedstock remain as the original powder feedstock. The sequence is repeated (350) to form a completed multi-layer solidified feedstock composite (352) surrounded by the original feedstock (332). The multi-layer solidified feedstock composite (352) is a body that contains the solidified feedstock of each formed layer, and is composed of the material of the solidified polymer and adsorbent particles of the feedstock. The original feedstock (332) can be removed and separated from the multi-layer composite (352).

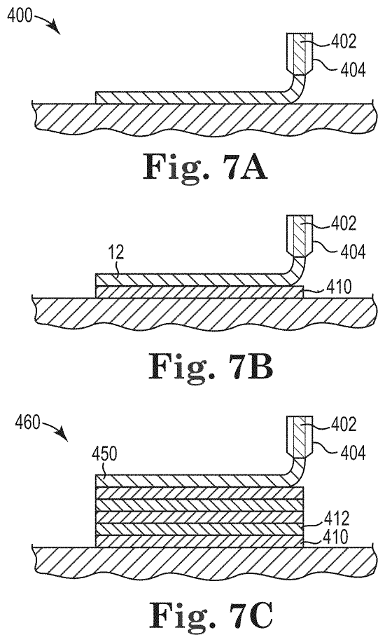

An example of a “feedstock dispensing” additive manufacturing technique (400) useful for preparing a multi-layer composite adsorption media as described herein is shown at FIGS. 7A, 7B, and 7C. Feedstock 402 is a flowable (e.g., liquid, high viscosity liquid, or “semi-solid” flowable material) that contains MOF particles in combination with a liquid curable polymer binder.

The process can be performed using commercially available additive manufacturing equipment and liquid polymeric binder combined with the MOF particles to form a semi-solid feedstock. According to example steps of the example method, semi-solid feedstock (402) is applied as a first feedstock layer by a printhead (or other useful device) (404), and is solidified to form a first solidified feedstock layer (410). The semi-solid feedstock may be in the form of a “slurry” or a “paste” that contains: a combination of two different types of adsorbent particles and binder composition. Feedstock in the form of a slurry or paste is made by mixing fine particles or powder of the adsorbent particles with solvent to make semi-liquid form to increase the flowability of the fine solid adsorbent particles of the powder.

In example feedstock materials useful in this type of method, the feedstock contains the two different types of adsorbent particles in combination with a polymer. Example polymers may be thermopolymers or a radiation-curable polymers.

The feedstock may contain useful amounts of adsorbent particles and polymer, such as: an amount in a range from 40 to 90 weight percent metal organic framework adsorbent; an amount in a range from 0 to 30 weight percent non-metal organic framework adsorbent; and an amount in a range from 10 to 30 weight percent polymeric binder, based on total weight feedstock.

The feedstock may be solidified by any useful mechanism, depending on the type of liquid in the feedstock material. If the liquid contains polymer that is chemically curable, the feedstock layer may be solidified by exposing the curable polymer to irradiation or heat that causes the polymer to cure. If the liquid contains thermopolymer that solidifies by exposure to a reduced temperature, the liquid may be solidified by exposure to a reduced temperature.

In a second step, as shown at FIG. 7B, a second solidified feedstock layer (412) is formed on the first solidified feedstock layer (410). Subsequent steps are used to form a desired number of added layers, including a final solidified feedstock layer (450), to form multi-layer composite adsorption media 460 (see FIG. 7C).

The multi-layer composite (452) may be further processed as desired to form a derivative structure, such as a MOF-type adsorbent material.

1. Composite adsorption media comprising:
first adsorbent particles,
second adsorbent particles, and
binder that holds together the first adsorbent particles and the second adsorbent particles as composite adsorption media.

2. The composite adsorption media of claim 1 comprising multiple layers of the composite formed by an additive manufacturing method.

3. The composite adsorption media of claim 1:
the first adsorbent particles comprising metal organic framework adsorbent, activated carbon adsorbent, porous organic polymer adsorbent, or zeolite adsorbent, and
the second adsorbent particles comprising metal organic framework adsorbent, activated carbon adsorbent, porous organic polymer adsorbent, or zeolite adsorbent, that is different from the first adsorbent particles.

4. The composite adsorption media of claim 1, the binder comprising polymeric binder.

5. The composite adsorption media of claim 1, the binder comprising inorganic particles.

6. The composite adsorption media of claim 1, wherein:
the first adsorbent particles are capable of adsorbing a first gas contained in a gas mixture that comprises the first gas and a second gas, and
the second adsorbent particles are capable of adsorbing the second gas contained in the gas mixture.

7. The composite adsorption media of claim 1, wherein the first gas can be adsorbed onto and selectively desorbed from the first adsorbent at selective desorption conditions that cause selective desorption of the first gas from the first adsorbent without substantial desorption of the second gas from the second adsorbent.

8. The composite adsorption media of claim 1, wherein:
the first adsorbent particles are capable of adsorbing GeF₄,
the second adsorbent particles are capable of adsorbing HF, PF₃, or both, and
the GeF₄ gas can be adsorbed onto and selectively desorbed from the first adsorbent particles at selective desorption conditions that cause desorption of the GeF₄ from the first adsorbent particles and a reduced amount of desorption of HF, PF₃, or both, from the second adsorbent particles.

9. The composite adsorption media of claim 1, wherein a form of a composite adsorption media body is selected from: a geometrically-shaped particle, a repeating lattice structure, a matrix, a honeycomb, and a monolith.

10. A storage vessel comprising:
composite adsorption media of claim 1 at an interior; and
a valve to control flow of gas into and out of the storage vessel.

11. The storage vessel of claim 10, further comprising:
GeF₄ adsorbed on the first adsorbent particles, and
HF, PF₃, or both, adsorbed on the second adsorbent particles,
wherein the GeF₄ can be selectively desorbed from the first adsorbent particles at selective desorption conditions that cause desorption of the GeF₄ from the first adsorbent particles, and a reduced amount of desorption of HF, PF₃, or both, from the second adsorbent particles.

12. The storage vessel of claim 10, further comprising:
hydride (e.g., SiH₄, GeH₄, AsH₃) or halide adsorbed on the first adsorbent particles, and
H₂O adsorbed on the second adsorbent particles,
wherein the hydride or halide can be selectively desorbed from the first adsorbent particles at selective desorption conditions that cause desorption of the hydride or halide from the first adsorbent particles, and a reduced amount of desorption of H₂O from the second adsorbent particles.

13. The storage vessel of claim 10, further comprising:
hydride (e.g., SiH₄, GeH₄, AsH₃) or halide adsorbed on the first adsorbent particles, and
hydrogen adsorbed on the second adsorbent particles,
wherein the hydride can be selectively desorbed from the first adsorbent particles at selective desorption conditions that cause desorption of the hydride from the first adsorbent particles, and a reduced amount of desorption of hydrogen from the second adsorbent particles.

14. The storage vessel of claim 10, further comprising:
phosphine adsorbed on the first adsorbent particles, and
diphosphine adsorbed on the second adsorbent particles,
wherein the phosphine can be selectively desorbed from the first adsorbent particles at selective desorption conditions that cause desorption of the phosphine from the first adsorbent particles, and a reduced amount of desorption of diphosphine from the second adsorbent particles.

15. The storage vessel of claim 10, further comprising:
germane adsorbed on the first adsorbent particles, and
digermane adsorbed on the second adsorbent particles,
wherein the germane can be selectively desorbed from the first adsorbent particles at selective desorption conditions that cause desorption of the germane from the first adsorbent particles, and a reduced amount of desorption of digermane from the second adsorbent particles.

16. The storage vessel of claim 10, further comprising:
fluoride (e.g., BF₃, GeF₄, SiF₄, PF₃) adsorbed on the first adsorbent particles, and
hydrogen fluoride (HF) adsorbed on the second adsorbent particles,
wherein the fluoride can be selectively desorbed from the first adsorbent particles at selective desorption conditions that cause desorption of the fluoride from the first adsorbent particles, and a reduced amount of desorption of hydrogen fluoride from the second adsorbent particles.

17. A method of adsorbing multiple different gases contained in a gas mixture onto composite adsorption media, the method comprising:
contacting a gas mixture with composite adsorption media that comprises:
first adsorbent particles,
second adsorbent particles, and
binder that holds together the first adsorbent particles and the second adsorbent particles as composite adsorption media,
adsorbing a first gas contained in the gas mixture onto the first adsorbent particles, and
adsorbing a second gas contained in the gas mixture onto the second adsorbent particles.

18. The method of claim 17, wherein:
the gas mixture comprises a reagent gas and two or more impurities,
the first impurity adsorbs onto the first adsorbent particles, and
the second impurity adsorbs onto the second adsorbent particles.

19. The method of claim 18, wherein:
reagent gas contacts the composite adsorption media and does not become adsorbed, and
the reagent gas is delivered to a semiconductor manufacturing tool (e.g., an ion implantation tool or a deposition tool).

20. The method of claim 17, wherein:
the gas mixture comprises reagent gas and impurity,
the reagent gas adsorbs onto the first adsorbent particles,
the impurity adsorbs onto the second adsorbent particles, and
the reagent gas can be selectively desorbed from the first adsorbent at selective desorption conditions that cause desorption of the reagent gas from the first adsorbent, and a reduced amount of desorption of the impurity from the second adsorbent.

21. The method of claim 20, wherein the composite adsorption media is contained in a storage vessel that comprises a cylinder having an interior and a valve to control flow of gas into and out of the storage vessel.

22. The method of claim 21, further comprising desorbing the reagent gas from the first adsorbent particles and dispensing the reagent gas from storage vessel to a semiconductor manufacturing tool.

23. The method of claim 22, wherein the reagent gas is GeF₄ and the impurity comprises HF, PF₃, or both.

24. The method of claim 17, wherein:
the gas mixture comprises reagent gas, stabilizing gas, and impurity,
the stabilizing gas adsorbs onto the first adsorbent particles,
the impurity adsorbs onto the second adsorbent particles.

25. The method of claim 17, wherein:
the gas mixture comprises an exhaust gas that comprises reagent gas and impurity,
the reagent gas adsorbs onto the first adsorbent particles,
the impurity adsorbs onto the second adsorbent particles, and
the reagent gas can be selectively desorbed from the first adsorbent particles at selective desorption conditions that cause desorption of the reagent gas from the first adsorbent particles, and a reduced amount of desorption of the impurity from the second adsorbent particles.

26. The method of claim 25, wherein the exhaust gas is from a semiconductor manufacturing tool.

27. The method of claim 25, wherein the impurity is impurity inert gas such as nitrogen, helium, xenon, or argon.

28. A method of making a composite adsorption media, the method comprising:
forming a first feedstock layer on a surface, the feedstock layer comprising feedstock that includes at least one of first adsorption media particles and second adsorption media particles;
forming solidified feedstock from the first feedstock layer;
forming a second feedstock layer over the first feedstock layer, the second feedstock layer comprising feedstock that includes adsorption media particles;
forming second solidified feedstock from second feedstock layer,
wherein the combination of first and second feedstock layers form a multilayer composite that contains the first adsorption media particles and second adsorption media particles.

29. The method of claim 28, comprising:
forming a first feedstock layer on a surface, the first feedstock layer comprising feedstock that contains at least one of first adsorption media particles and second adsorption media particles;
at portions of the first feedstock layer, selectively applying liquid to the feedstock layer to produce a solidified feedstock form the first feedstock layer;
forming a second feedstock layer over the layer that contains the solidified feedstock, the second layer comprising feedstock that contains adsorption media particles; and
at portions of the second feedstock layer, selectively applying liquid to the second feedstock layer to form second solidified feedstock.

30. The method of claim 29 wherein:
the feedstock layer comprises inorganic particles as a binder component,
the liquid comprises distilled water, and
applying the liquid to the feedstock layer produces the solidified feedstock.

31. The method of claim 30, comprising reducing the temperature of the first solidified feedstock layer and the second feedstock layer to a temperature below zero degrees Celsius, to cause the liquid to freeze.

32. The method of claim 28, comprising:
forming a first feedstock layer on a surface, the first feedstock layer comprising feedstock that contains binder composition and at least one of first adsorption media particles and second adsorption media particles;
at portions of the first feedstock layer, selectively applying radiation to the first feedstock layer to produce a solidified feedstock comprising the first feedstock layer;
forming a second feedstock layer over the layer that contains the solidified feedstock of the first feedstock layer, the second feedstock layer comprising feedstock that contains adsorption media particles and binder composition;
at portions of the second feedstock layer, selectively applying radiation to the second feedstock layer to form second solidified feedstock layer.

33. The method of claim 28, comprising:
providing feedstock that contains first adsorption media particles, second adsorption media particles, and binder composition;
selectively applying the feedstock to a surface to form a path of the feedstock on the surface, the path having an upper path surface;
causing the feedstock of the path to solidify; then
applying the feedstock to the upper surface to form a second path of the feedstock on the second surface.

34. The method of claim 28, wherein the feedstock for the first feedstock layer and the feedstock for the second feedstock layer both comprise the first adsorption media particles and the second adsorption media particles.

35. The method of claim 28, wherein the feedstock for the first feedstock layer comprises one of the first adsorption media particles and the second adsorption media particles and the feedstock for the second feedstock layer comprises the other of the first adsorption media particles and the second adsorption media particles.

36. A method of preparing composite adsorption media for processing a gas mixture, the method comprising:
for a gas mixture that includes a first gas and a second gas,
selecting first adsorbent particles to adsorb the first gas,
selecting second adsorbent particles to adsorb the second gas, and
forming a composite adsorption media comprising:
the first adsorbent particles,
the second adsorbent particles, and
binder that holds together the first adsorbent particles and the second adsorbent particles as composite adsorption media.
